(19) United States
(12) Patent Application Publication
(10) Pub. No.: US 2014/0113263 A1
(43) Pub. Date: Apr. 24, 2014

(54) Clinical Training and Advice Based on Cognitive Agent with Psychological Profile

(71) Applicants: Bruce Jarrell, Severna Park, MD (US); Sergei Nirenburg, Reisterstown, MD (US); Marjorie Joan McShane, Reisterstown, MD (US); Stephen Beale, Baltimore, MD (US); George Fantry, Towson, MD (US)

(72) Inventors: Bruce Jarrell, Severna Park, MD (US); Sergei Nirenburg, Reisterstown, MD (US); Marjorie Joan McShane, Reisterstown, MD (US); Stephen Beale, Baltimore, MD (US); George Fantry, Towson, MD (US)

(73) Assignees: THE UNIVERSITY OF MARYLAND, BALTIMORE COUNTY, Baltimore, MD (US); THE UNIVERSITY OF MARYLAND, BALTIMORE, Baltimore, MD (US)

(21) Appl. No.: 13/656,688

(22) Filed: Oct. 20, 2012

(51) Int. Cl. G09B 19/00

(52) U.S. Cl. CPC G09B 19/00
USPC 434/262

(57) ABSTRACT

A method and apparatus for a clinical simulation system targets psychological phenomena that can negatively impact the decision making of both a clinician and a patient. Techniques include identifying an independently reasoning agent in a medical clinical information processing system configured to simulate interactions between a clinician and a patient. The method also includes determining, on the system, psychological profile data that indicates one or more personality traits for the agent. The method further includes storing psychological profile data on the system in a hierarchical data structure for a natural language processing system. The method still further includes determining simulation output from the system based at least in part on the psychological profile data.

### BACKGROUND OF THE INVENTION

Medical care delivery is major industry in the United States. An important component of medical care delivery is a cadre of trained medical care professionals who can diagnose patient condition and prescribe treatment protocols using cognitive skills. The fewer errors made by this cadre, the better is the medical care delivered. Currently, cognitive skills of medical care professionals are developed by close interaction with other members of the profession who are already highly skilled and serve as mentors. Of those already skilled only some are good mentors. The more people trained by the good mentors, the better the medical care delivered.

Individuals who are both good physicians and good mentors have limited time, energy and patience to effectively train all medical care profession students and professionals undergoing continuing medical education, collectively called herein medical trainees. To compound the problem, trainees have a limited time to train. Both mentors and trainees would greatly benefit from an automated system that takes on some or most of this burden.

Recently, medical trainees have had their workweek limited to 80 hours. Under this constraint, they must safely complete their required patient care duties while still fulfilling the requirements of a rigorous educational program. In addition, the content of this educational program must evolve continuously by being updated and re-prioritized given the remarkable progress in areas such as the human genome project and molecular biology. Physicians are expected to remain broadly knowledgeable and specifically expert, yet there are no good automated methods to support accomplishing these expectations. Currently, physicians learn information through reading, conferences, one-on-one discussions with experts who are effective mentors, and trial-and-error management of real patients. Safer and more efficient methods for becoming expert and reducing error rates prior to patient contact are desirable.

One approach to training and advising clinicians is to provide realistic training for specific tasks. For example, manikins to teach the care of infants and adults have been developed by LAERDAL, INC.™ of Wappingers Falls, New York (e.g., “SimBaby”) and METI, INC. of El Paso, Tex. (e.g., “The Human Patient Simulator”), respectively. These focus on training a specific technical step, with little or no cognitive simulation.

Another approach is cognitive training on computers. Among the computer methods to train decision making skills are systems based on decision trees that embody diagnostic and treatment algorithms at the case level. These include no biomechanistic processes, and the user is limited to selecting one of the pre-scripted options at fixed points in case (see, e.g., E. H. Shortliffe, “The computer and clinical decision making: Good advice is not enough,” in IEEE Engineering in Medicine and Biology Magazine, v8, pp. 16-18, 1982).

Another approach is the use of traditional expert systems (see, e.g., Buchanan, B. and E. Shortliffe, Rule-Based Expert Systems: The Mycin Experiments of the Stanford Heuristic Programming Project, Addison-Wesley, New York, 1984), which accumulate expertise from a variety of sources but do not address natural language interaction or simulation.

Another approach is to use hybrid models, such as those that combine the Foundational Model of Anatomy with a stochastic physiological knowledge at the cell, tissue, body and population levels. A well-known simulation project of this type is the Virtual Soldier, which simulates the human thorax in the context of penetrating trauma. It does not address the long-term treatment of patients with ever changing disease states.

Another approach is to use statistical models of patient properties from a large population. See, e.g., W. Sumner and M. Hagen, “Computer Architecture and Process of Patient Generation,” Evolution and Simulation for Computer Based Testing System Using Bayesian Networks as a Scripting Language. U.S. Pat. No. 7,024,399, 2006. However, this approach does not yet support a realistic simulation of the virtual patient's physiological or psychological processes.

Other approaches combine natural language dialog with expert systems. For example, the CIRCSIM project (see, e.g., M. Evens and J. Michael, One-on-One Tutoring by Humans and Computer, Lawrence Erlbaum and Associates, Publishers, New Jersey, 2006) concentrates on tutoring in a medical domain and involves natural language dialog. However, CIRCSIM-Tutor currently does not incorporate simulation, and it covers only one specific medical condition, the baroreceptor reflex—the body's rapid response system for dealing with changes in blood pressure. As another example, a dialog system in the framework of a tutoring environment for medical students is being developed for language processing (see, e.g., S. McRoy, S. A. Syed, S. M. Haller, “Uniform knowledge representation for language processing in the B2 system,” Journal of Natural Language Engineering, v3, no. 3, 1997); but it focuses on dialogue issues without detailed specification of physiological and pathological or psychological states.

### SUMMARY OF THE INVENTION

Techniques are provided for ongoing enhancements to a clinical simulation environment, including general training and case-specific advising of clinicians, which target psychological phenomena that can negatively impact the decision making of both a clinician and a patient.

In a first set of embodiments, a method includes identifying an independently reasoning agent in a medical clinical information processing system configured to simulate interactions between a clinician and a patient. The method also includes determining, on the system, psychological profile data that indicates one or more personality traits for the agent. The method further includes storing psychological profile data on the system in a hierarchical data structure for a natural language processing system. The method still further includes determining simulation output from the system based at least in part on the psychological profile data.

In various other sets of embodiments, an apparatus or a non-transient computer-readable medium are configured to perform one or more steps of the above method.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates an example medical clinical information processing system configured to simulate interactions between a clinician and a patient, according to an embodiment;

FIG. 2 is a block diagram that illustrates an example reasoning engine for an independently reasoning agent in the system of FIG. 1, according to an embodiment;

FIG. 3A and FIG. 3B are block diagrams that illustrate an example hierarchical data structure for a natural language processing system, according to an embodiment;

FIG. 4 is a block diagram that illustrates an example natural language processor, according to an embodiment;

FIG. 5 is a flow chart that illustrates an example method for simulating an independently reasoning agent in the system, according to an embodiment;

FIG. 6A is a block diagram that illustrates an example instance of a virtual patient agent in the hierarchical data structure, according to an embodiment;

FIG. 6B is a block diagram that illustrates an example instance of psychological profile data for an agent in the hierarchical data structure, according to an embodiment;

FIG. 6C is a block diagram that illustrates an example instance of memory for an agent in the hierarchical data structure, according to an embodiment;

FIG. 6D is a block diagram that illustrates an example instance of a patient chart in the hierarchical data structure used by an independently reasoning agent that represents a clinician who is treating the patient, according to an embodiment;

FIG. 7A is a block diagram that illustrates an example disease concept in the hierarchical data structure for storing expert knowledge about a disease, according to an embodiment;

FIG. 7B is a block diagram that illustrates an example medical test concept in the hierarchical data structure for storing expert knowledge about a medical test, according to an embodiment;

FIG. 7C is a block diagram that illustrates an example medical treatment concept in the hierarchical data structure for storing expert knowledge about a medical treatment, according to an embodiment;

FIG. 8A, FIG. 8B and FIG. 8C are block diagrams that illustrate an example achalasia concept in the hierarchical data structure for storing expert knowledge about the disease achalasia, according to an embodiment;

FIG. 8D is a block diagram that illustrates an example instance of the disease achalasia in the hierarchical data structure, according to an embodiment;

FIG. 9A, FIG. 9B, FIG. 9C and FIG. 9D are graphs that illustrate example simulations of the progression of the instance of achalasia of FIG. 8D in response to various treatments and treatment times, according to an embodiment;

FIG. 10A is a flow chart that illustrates an example method for executing a reasoning module that depends on psychological profile data to determine simulation output that represents the agent's response, according to an embodiment;

FIG. 10B is a flow chart that illustrates an example method for executing a step of the method of FIG. 10A that further depends on psychological profile data, according to an embodiment;

FIG. 11 is a flow chart that illustrates an example method for executing a reasoning module that depends on psychological profile data of a patient to determine simulation output that recommends a medical procedure, according to another embodiment;

FIG. 12A and FIG. 12B are block diagrams that illustrate an example interface for presenting simulation output to a clinician, according to another embodiment;

FIG. 13A, FIG. 13B and FIG. 13C are flow charts that illustrate an example method for executing a reasoning module to determine psychological profile of an patient and clinician and produce simulation output that represents the evaluation of a clinician or patient, according to an embodiment;

FIG. 14 is a block diagram that illustrates a computer system upon which an embodiment of the invention may be implemented; and

FIG. 15 illustrates a chip set upon which an embodiment of the invention may be implemented.

### DETAILED DESCRIPTION

A method and apparatus are described for a clinical simulation system that targets psychological phenomena that can negatively impact the decision making of both a clinician and a patient. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. In the following, one or more references are cited. In each case the entire contents of the reference is hereby incorporated as if fully set forth herein, except for terminology that is inconsistent with the terminology used herein.

Some embodiments of the invention are described below in the context of a virtual patient or a real patient with a particular disease, achalasia, and a virtual mentor that is expert in diagnosing this disease or detecting personality traits of a real or virtual patient or detecting biases in a real clinician, or some combination. However, the invention is not limited to this context. In other embodiments, patients with one or more and different diseases, or normal patients without a disease are included, and other independently reasoning agents are included, such as mentors with other expertise or other clinicians or technicians for various medical procedures (e.g., X-rays and laboratory tests), or persons associated with the patient (e.g., a relative of the patient or caregiver for the patient). As used herein, the term clinician refers to doctors, doctors' assistants, medical students, nurses, laboratory technicians and any others participating in or training for assessing medical state or delivering medical care to a human or animal patient.

### 1. Overview

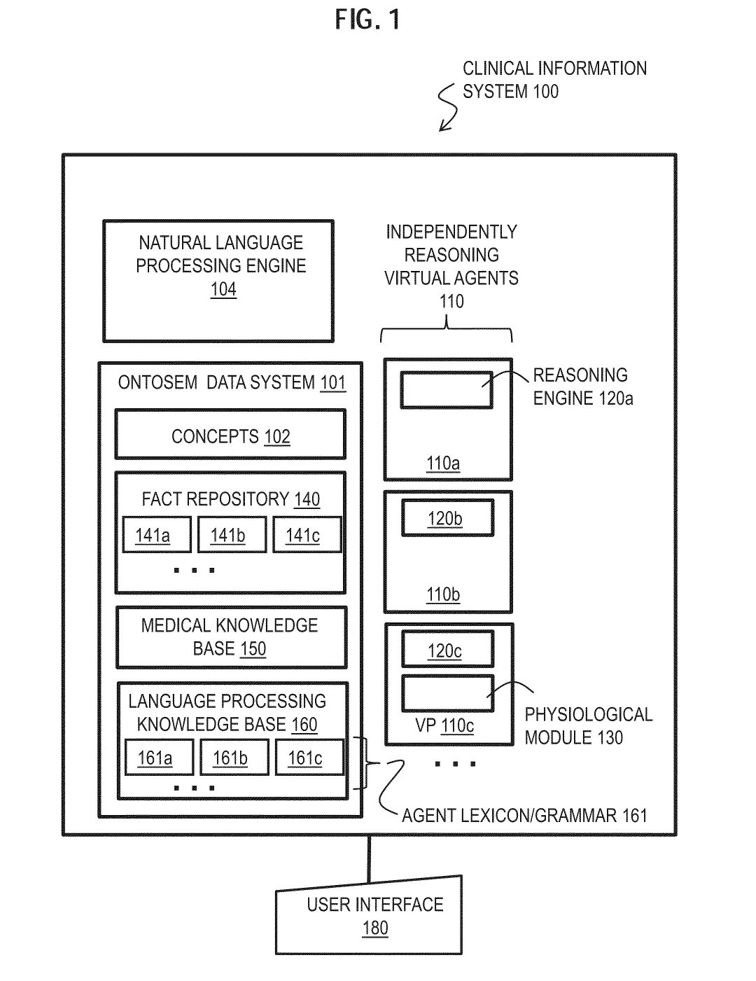

FIG. 1 is a block diagram that illustrates an example medical clinical information processing system (called a clinical information system 100, herein) configured to simulate interactions between a clinician and a patient, according to an embodiment. In some embodiments, the clinician is a real person and the patient is a virtual patient. In some embodiments, the patient is a real person and the clinician is a virtual mentor which determines a preferred way of interacting with the patient to determine proper medical hypotheses, diagnoses or procedures (the latter including medical tests and medical treatments). In some embodiments, both the patient and mentor are virtual and a real trainee interacts with both. In some embodiments a standalone simulation is performed and no real person interacts with the system 100. In each embodiment, an independently reasoning agent is implemented in the system 100 to represent each real or virtual human interacting through the system.

For example, in some embodiments, the system 100 is configured to train a real person who is a medical clinical trainee (called a trainee, hereinafter) on general patient interactions and medical principles based on one or more example virtual patients with corresponding psychological profiles and physiological processes. In some embodiments, the system is configured to evaluate the trainee interaction with a virtual patient by determining a psychological profile for the trainee. In some embodiments, the system is configured to advise a real person who is a clinician or clinical trainee on specific procedures and interactions with a real patient using a virtual mentor which determines best practices as well as the psychological profile of the clinician or trainee or patient, or some combination. In some embodiments, the interactions between the independently reasoning virtual agents is controlled though natural language generation and interpretation based on the language, knowledge and skills of individual agents.

The number of simultaneously launched agents is based on the purpose of the simulation for the system 100. In some embodiments, multiple simulations with corresponding different purposes are performed simultaneously by the system 100. For example, some simulations are performed to advise a clinician on the best way to interact (by speech or medical procedure) with a real patient, other simulations are performed to allow a clinician trainee to interact with a virtual patient, and yet others are performed to allow a virtual mentor to watch and evaluate or intervene with the trainee or experienced clinician, or perform some combination of functions.

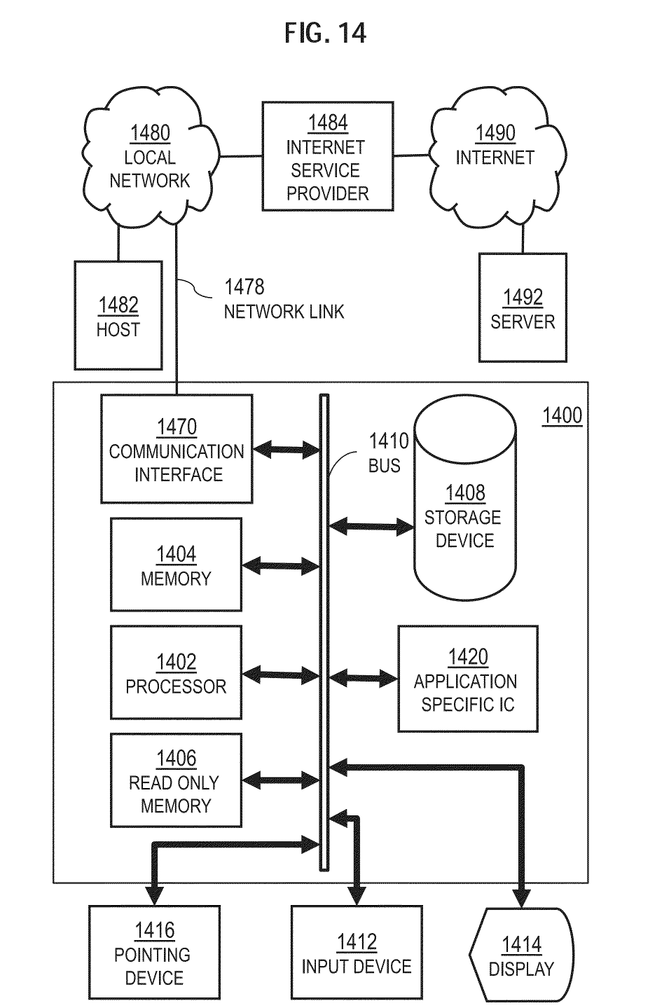

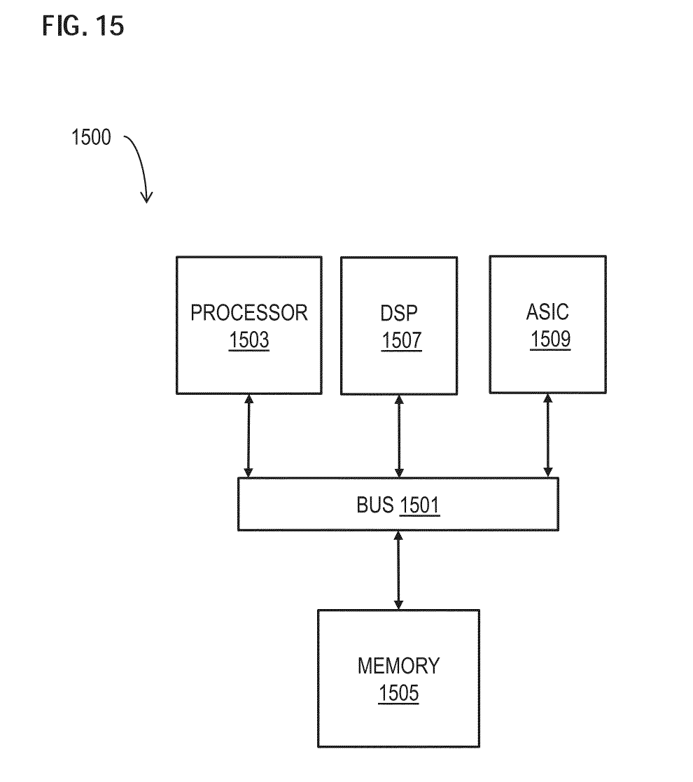

The system 100 includes one or more instances of a user interface 180, such as a computer terminal or a graphical user interface on a computer or a tablet or other equivalent device, through which a real person, if any, interacts with the other components of the system 100. The other components include one or more modules and data structures, such as databases, which reside on one or more computer systems or chip sets, as described in more detail below with reference to FIG. 14 and FIG. 15, respectively.

The system 100 includes one or more independently reasoning virtual agents 110, such as agent 110a, 110b and 110c, among others indicated by ellipsis. Each independently reasoning virtual agent 110 includes a reasoning engine, such as reasoning engines 120a, 120b and 120c (collectively referenced hereinafter as reasoning engines 120) in virtual agents 110a, 110b and 110c, respectively. For example, in some embodiments, one of the virtual agents is a virtual mentor which is capable of reasoning as an experienced clinician in terms of medical knowledge or patient interactions or both. In some embodiments, at least one of the virtual agents 110 is a virtual patient (VP), such as VP 110c, which includes a physiological module 130. The physiological module 130 simulates the evolution of a medical state of the virtual patient, as described in more detail below.

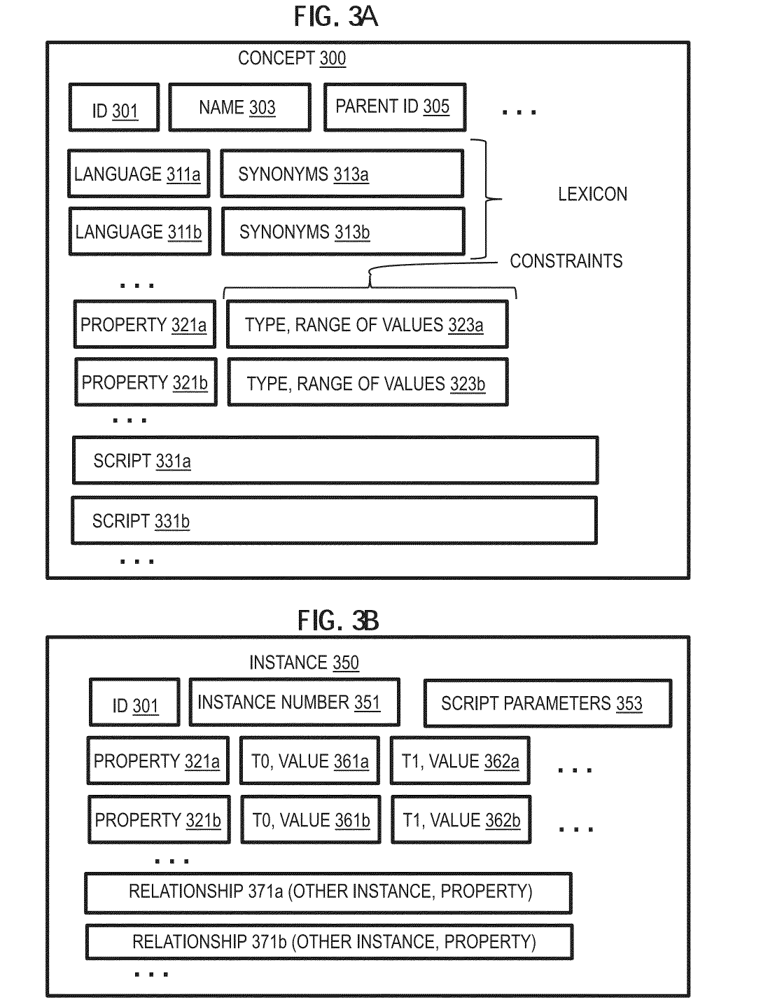

The system 100 includes a hierarchical data structure for a natural language processing system, such as the OntoSem data system 101, used for storing semantic concepts for an OntoSem natural language processing system (e.g., see US published patent application US-2008-0015418). The OntoSem ontology is fundamentally different from most other ontologies in its emphasis on rich property-based descriptions that are not present in the many hierarchical trees of words or concepts available both within the medical domain (e.g., Unified Medical Language System [UMLS]) and outside of it (e.g., WordNet). The term ontology is used in a general sense of identifying what entities exist or can be said to exist, and how such entities can be grouped, related within a hierarchy, and subdivided according to similarities and differences. Concepts in OntoSem are connected hierarchically through subsumption relations, so that properties defined in ancestor concepts (metaclasses) are valid in the descendant concepts, unless overtly overridden. OntoSem permits multiple inheritance: for example, animal-disease class inherits both from medical-event class and from pathologic-function class. At the time of this writing, the OntoSem ontology contains about 9,000 concepts, with, on average, about 16 properties each. The ontology includes both general purpose and biomedicine concepts. The concepts in the OntoSem ontology constitute a metalanguage for representing all information in the system 100. In an illustrated embodiment, all aspects of agent functioning, from physiological simulation to decision-making to communicating in natural language to learning new information are supported by the same knowledge substrate encoded in this single metalanguage. This approach provides an advantage in reducing development effort and cost, and allowing new functions to be added in a modular fashion. An hierarchical data structure for a natural language processing system, such as OntoSem, is described in more detail below with reference to FIG. 3A.

In an illustrated embodiment, the hierarchical data structure is implemented as objects in an object-oriented computer language. The advantage of an object-oriented computer language is that it easily supports valuable aspects of the hierarchical data structure, for example, the properties of a concept are represented as attributes of an object, the scripts of a concept are represented as methods of an object, inheritance of attributes and methods by one object from another supports inheritance of specific concepts from general concepts, and generating multiple instance objects of a generic object supports generating multiple instances of a disease in an individual patient from a generic description of the disease in the ontology.

The OntoSem data structure 101 includes concepts of the metalanguage 102, a fact repository for one or more agents simulated in the system, a medical knowledge base 150 and a language processing knowledge base 160 for individual agents. The facts repository 140 includes memories of thoughts and experiences of individual agents, such as memories 141a, 141b, 141c among others indicated by ellipsis for corresponding virtual agents 110a, 110b, 110c, among others. The language processing knowledge base 160 includes the lexicon (e.g., vocabulary and syntax and idioms) of individual agents, such as lexicons 161a, 161b, 161c among others indicated by ellipsis for corresponding virtual agents 110a, 110b, 110c, among others.

In some embodiments, the system includes a natural language processing engine 104 which serves as the basic processor for one or more of the other engines in the system 100. The engine 104 executes any invoked scripts in the hierarchical data structure, retrieving data from the data system 101. For example, natural language processing engine 104 generates instances of concepts from concepts store 102 and stores those instances in data system 101, e.g., as facts in fact repository 140, and converts concepts into the lexicon of individual agents 110 or text from individual agents into concepts or some combination.

Although data structures, messages and fields are depicted in FIG. 1, and subsequent diagrams, as integral blocks in a particular order for purposes of illustration, in other embodiments, one or more data structures or messages or fields, or portions thereof, are arranged in a different order, in the same or different number of data structures or databases in one or more hosts or messages, or are omitted, or one or more additional fields are included, or the data structures and messages are changed in some combination of ways.

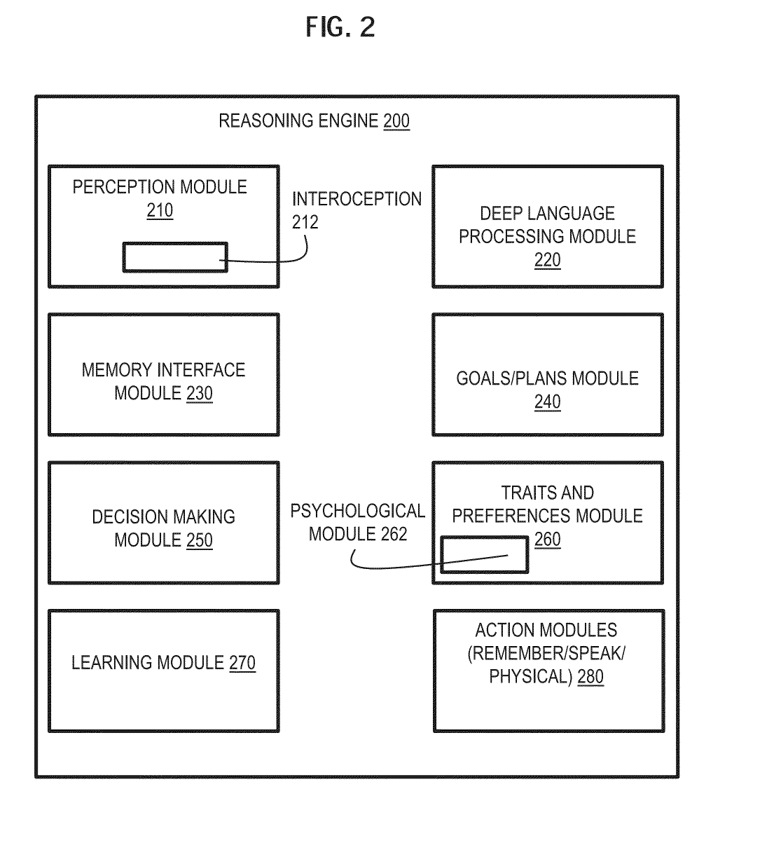

FIG. 2 is a block diagram that illustrates an example reasoning engine 200 for an independently reasoning agent 110 in the system 100 of FIG. 1, according to an embodiment. Thus engine 200 is a particular embodiment of the reasoning engine 120 depicted in FIG. 1. The illustrated reasoning engine 200 includes a perception module, deep language processing module 220, memory interface module 230, goals and plans module 240, a decision making module 250, a traits and preferences module 260, a learning module 270 and one or more action modules 280. In other embodiments, one or more of these modules are omitted or additional modules are added.

The perception module 210 is configured to determine what the virtual agent perceives, e.g., external environment such as ambient light and time. In the illustrated embodiment, the perception module 210 includes an interoception module 212 that is configured to determine what the agent perceives about internal conditions based on the physiological module 130, if present, such as hunger and discomfort or other symptoms associated with one or more diseases to which the agent, such as a virtual patient instance, is subject. In some embodiments, the interoception module 212 operates a set of demons that are programmed (a) to notice the changes in values of specific physiological parameters and (b) if these values move outside a certain range, to instantiate corresponding symptoms in the VP's memory. Symptoms are represented as values of properties in the VP's profile of self, which is an instance of the ontological concept human stored in its fact repository. In some embodiments, the perception module 210 uses instructions of the natural language processing engine 104. In some embodiments, e.g., in some agents representing a real person operating the system 100, the perception module 210 is omitted.

The deep language processing module 220 is configured to determine meaning of text received by the agent based on concepts and syntax of the text, or to generate text that represents output from the agent directed to another agent in the system 100, or both. Deep language processing includes semantic and pragmatic analysis and language generation. Any deep language processing system may be used. In some embodiments, the deep language processing module 220 uses instructions of the natural language processing engine 104. In some embodiments, concepts alone are determined based on received text, and syntax of output text, if any, is scripted based on a template or concepts 102 or the agent's individual lexicon 161 or some combination, using the natural language processing engine 140 alone; and, module 220 is omitted.

The memory interface module 230 is configured to retrieve facts from the agent's individual memory 141 in the data system 101, and to place into the agent's individual memory 141 new facts, if any, learned by the agent. In the illustrated embodiment, each fact is an instance of a concept, as described in more detail below. For example, facts in memory include the content of the VP's short-term memory, which is modeled as knowledge invoked specifically for making a decision at hand, and the content of the VP's long-term memory, which is the VP's recollection of its past states of health, past communications and decisions, knowledge of self (preferences, fears, etc., which might be an imperfect understanding of the VP's actual personality traits) and general world knowledge. In some embodiments, the agent's memory 141 in the fact repository 140 includes, among other things: (a) noteworthy aspects of other agents' ontologies (e.g., “the doctor has a large medical supplement that I don't have”), (b) the agent's own beliefs about others' beliefs (“the doctor thinks I'm lying”), (c) the agent's assumptions about the decision-making processes of others (“the doctor is telling me to do surgery because he is a surgeon and has a bias toward surgery”), (d) the agent's interpretation of others' character traits (“the doctor is compassionate and has my best interests at heart”). In some embodiments, the module 230 uses instructions of the natural language processing engine 104.

The goals and plans module 240 is configured to determine the goals and plans of the agent from among the facts in the repository 140. Goal refers to a state the agent wishes to reach, and plans are one or more means available to the agent for arriving at that goal. Goals and plans relevant to the simulation, at least, are advantageously included. For example, in some embodiments of a clinical setting, the patient's goals in English are “Talk to me, answer my questions, and solve my problem in a way that suits my body, my personal situation and my preferences” but are actually expressed in the metalanguage. In some such embodiments, the doctor's goals in English are, “Make an accurate diagnosis; have a compliant patient who is informed about the problem and his options, and makes responsible decisions; and launch an effective treatment.” In some embodiments, the module 240 uses instructions of the natural language processing engine 104. In some embodiments module 240 is omitted.

The decision making module 250 is configured to determine a next action for the agent to take based on the facts in the agent's memory 141 retrieved through module 230, or the meaning determined from the natural language processing of text from the other agents, such as available from the module 220, or the agent's own goals and plans available from the module 240, or some combination. For example, in some clinical setting embodiments, the decision-making capabilities of virtual patients include: deciding when to go see a physician, both initially and during treatment; deciding whether to seek help in making decisions related to treatment by asking another agent knowledge-seeking questions about a recommended test or treatment; deciding whether to agree to a recommended test or treatment; and deciding on certain aspects of lifestyle (e.g., drinking caffeinated beverages, smoking, exercise type and frequency). In an illustrated embodiment, the decision-making behavior of instances of VPs also depends on personality traits available from the module 260 described below. In some embodiments, the module 250 uses instructions of the natural language processing engine 104. Each independently reasoning virtual agent includes at least module 250.

The traits and preferences module 260 is configured to determine parameters that describe individualized personality traits of a particular agent, which herein includes character traits (e.g., courage, suggestibility, boredom threshold etc.) and personal preferences (e.g., likes coffee, is afraid of surgery). Personality traits are described in more detail below. In some embodiments, the module 260 uses instructions of the natural language processing engine 104.

In the illustrated embodiments, the traits and preferences module 260 includes a psychological module 262 that is configured to determine values for one or more personality traits of the agent, or another agent based on interactions with that agent. Prior profiles are retrieved from the agent's memory 141 and updated profiles are stored into the agent's memory 141 through the memory interface module 230. In various embodiments the personality traits of an agent include one or more values for one or more corresponding first parameters selected from a group comprising trustfulness, lifestyle type, tolerance to risk, tolerance to pain, tolerance to disability and suggestibility. In the illustrated embodiment, the personality traits of an agent include one or more values for one or more corresponding additional parameters selected from a group comprising intellect, interest in learning, compassion, perception, trustworthiness, self image, affability, temper, education level, areas of expertise, beliefs, biases and phobias. In some embodiments the psychological profile data also indicates one or more mental states, such as values for one or more parameters comprising stress (e.g., due to anxiety, discomfort, pain, exhaustion, hunger), defensiveness and alertness, among others. In some embodiments, the module 260 uses instructions of the natural language processing engine 104.

The learning module 270 is configured to determine what experiences in the form of new concepts and additions to a lexicon resulting from text received from reading or being told by another real or virtual agent (e.g., from module 220), and what dialog and actions in which the agent was engaged (e.g., from module 280, described below) are added to the memory of the agent. For example, the VP learns the name of its disease, various properties of the disease and various procedures for testing or treating the disease from text received from the real or virtual clinician. As a further example, the VP remembers its symptoms (from module 212), the procedures it undergoes (from module 210), its conversations with the doctor (from modules 220), and important events in its simulated life from module 280 (e.g., kicking a caffeine habit, increasing exercise). As another example, a virtual mentor remembers all the information provided by the real or virtual patient (e.g., from module 220), all the moves made by the trainee (e.g., from module 280 of the trainee), all the advice it gave the trainee (e.g., from its own module 280). As an example of an advisor to a practicing clinician, the virtual mentor learns everything about the patient that is recorded by the clinician (e.g., in a patient chart described below), the clinician's actions and the clinician's preferences and tendencies (as generalized over time), e.g., from the clinician's module 280. In some embodiments, the module 270 uses instructions of the natural language processing engine 104. In some embodiments module 270 is omitted.

The action modules 280 are configured to determine one or more actions taken by the agent, e.g. in response to the decision from module 250. For example, in the illustrated embodiment the actions include the patient remembering certain facts by passing those facts to the learning module 270, speaking by passing the meaning to be expressed to the deep processing module 220, and physical acts, such as dieting or visiting the doctor, by passing data about that decision to the physiological module 130, if present, or other action module (e.g., to instantiate a medical procedure including taking a prescribed medication). In some embodiments, one or more of the modules 280 uses instructions of the natural language processing engine 104.

Thus, in various embodiments, simulation output from the system 100 is based at least in part on the psychological profile data of psychological module 262.

FIG. 3A and FIG. 3B are block diagrams that illustrate an example hierarchical data structure for a natural language processing system, according to an embodiment. This data structure is used in the system 100 according to some embodiments. The example hierarchical data structure represents one concept 300 in the ontology. This can be a fundamental concept that is based on no other concepts, or a hybrid concept that has one or more other concepts as one or more properties. Concepts can be categorized as events, objects and properties (relations and attributes). The objects and events are described using the properties. At least some properties are primitives—i.e., their meaning is understood to be grounded in the real world without the need for further ontological decomposition.

In the illustrated embodiment, the concept 300 includes an identification (ID) field 301, a name field 303 and a parent identification field 305, among other fields indicated by ellipsis. The ID field 301 holds data that uniquely identifies the concept, such as a sequence number or a random access computer memory address or primary key in a database. The name field 303 holds data that indicates a name for the concept; this name is a member of the metalanguage and can be expressed in any language or be invented. For convenience, the name is often selected to be in a designer's native tongue, such as English. The parent ID field holds data that indicates the ID field of a different concept, if any, that is a parent to the current concept, from which the current concepts inherits one or more properties or scripts. For example, the concept human may inherit one or more properties or scripts from the concept “mammal” which may inherit one or more properties and scripts from the concept “animal.” In other embodiments, one or more other fields are included, such as a field holding data that indicates a part of speech associated with the concept (e.g., noun, transitive verb, intransitive verb, adjective, adverb, preposition) or a field holding data that indicates a number of different languages that the system supports for this concept, or a field that holds data that indicates a concept ID of an opposite concept, if any, such as the concept “inexpensive” as an opposite for the concept “expensive.”

The concept name is sufficient for storing facts and performing reasoning. However, to support natural language processing, in the illustrated embodiment, the concept includes one or more properties that belong to a lexicon. For example, in the illustrated embodiment the lexicon includes one or more language fields, such as 311a, 311b and ellipsis, collectively referenced hereinafter as language fields 311. Each language field holds data that indicates a language supported by the natural language processing system. For each language specified in a language field 311 there is additional information about the concept in that language. For example, in the illustrated embodiment there is a synonym field 313, 313b and others indicted by ellipses, collectively referenced hereinafter as synonyms fields 313, for corresponding language fields 311a, 311b and others. Each synonyms field 313 holds zero or more synonyms for the concept in that language. For example, the concept “white,” part of speech “adjective,” has the synonyms “colorless,” “bright,” “light” in the language “English.” In other embodiments one or more other fields are included, such as homonym fields for words of a different concept that sound the same. Such homonym fields are useful for removing ambiguity in text received by the system as spoken words.

The concept 300 further includes one or more property fields 321a, 321b or others indicated by ellipsis, collectively referenced hereinafter as properties 321. Each property field 321 holds data that indicates a name for a property of the concept. For example the concept “box” has three property fields, one holding data that indicates “length,” one holding data that indicates “width” and one holding data that indicates “height”. The properties may be primitives or refer to a different concept.

Associated with each property is a constraints field, such as constraints fields 323a, 323b and others indicated by ellipsis, collectively referenced hereinafter as constraints fields 323. The constraints fields 323 each holds data that indicates any constraints on values that can be used for the corresponding property. For example the constrains field for the property “width” holds data that indicates values are numeric with a range from 0 to unlimited and that the value for the property width is less than or equal to the value for the property “length” and greater than or equal to the value for the property “height.” In some embodiments, the constraints field 323 includes a default value to use in the absence of other information. The expressive power of the ontology is enhanced in some embodiments by multivalued fillers for properties, implemented using facets. Facets permit the ontology to include information such as “the most typical colors of a car are white, black, silver and gray; other normal, but less common, colors are red, blue, brown and yellow; rare colors are gold and purple.” The inventory of facets includes: default, which represents the most restricted, highly typical subset of fillers; sem, which represents typical selectional restrictions; relaxable-to, which represents what is possible but is not typical; range, as described above; and value, which represents not a constraint but an actual, non-overridable value. The fillers for many properties are inherited rather than locally specified. The meaning of an object in the ontology is the meaning of its set of property-facet-value triplets. In some embodiments, the properties and constraints of the parent concepts are inherited by the child concept without being repeated in the child concept. The property and constraint can be found by following the links to the parents via the value in parent ID field 305.

The concept 300 further includes one or more script fields 331a, 331b or others indicated by ellipsis, collectively referenced hereinafter as scripts 331. Each script field 331 holds data that indicates a process to be performed, such as a pointer to a set of computer instructions. In some embodiments, the script field 331 includes data that indicates concepts for which values are input and concepts for which values are output by the script, such concepts are called script parameters. In some embodiments, events in the simulation are concepts in which the property fields 321 indicate the input and output parameters and the script field 331 holds data that indicates computer instructions to convert values for the input parameters into values for the output parameters. In some embodiments, the scripts of the parent concepts are inherited by the child concept without being repeated in the child concept. The script can be found by following the links to the parents via the value in parent ID field 305. In some embodiments, each concept includes a script 331 that generates an instance of the concept.

An instance of a concept differs from its concept by having particular values for all properties. Naturally, the values satisfy the constraints specified for the properties of the concept. In some embodiments, the instance does not include a copy of the script but relies on the scripts in the parent. FIG. 3B is a block diagram that illustrates an example instance 350 generated from the concept 300. For example, the instance 350 represents a particular box generated from the concept “box” or a particular virtual patient generated from the concept “virtual patient,” the latter described in more detail in a later section.

The instance 350 includes a concept ID field 301, an instance number field 351 and script parameters field 353. The concept ID field 301 holds data that unique identifies the concept from which the instance was generated, e.g., holds the same data as depicted in field 301 for concept 300. The instance number field 351 holds data that uniquely indicates this instance distinct from any other instances that were generated by the system 100 for this same concept indicated in field 301. Although called an instance number, in other embodiments the field 351 holds data that indicates one or more letters. The script parameters field 353 holds data that indicates the properties that serve as input and output parameters for each script that can be invoked by the instance 350.

For each property in the concept, indicated in the property fields 321 repeated in the instance 350, there is a value at one or more times. For example, property 321a is associated with a first value at a first time (T0) indicated by data in field 361a and a second value at a second time (T1) indicated by data in field 362a or more values at other times indicated by ellipsis. Similarly, property 321b is associated with a first value at a first time (T0) indicated by data in field 361b and a second value at a second time (T1) indicated by data in field 362b or more values at other times indicated by ellipsis. Similar time value pairs are associated with other properties indicated by ellipsis. The data held in fields 361a, 362a, 361b, 362b or others indicated by ellipses are collectively called value fields 360. In some embodiments, the time values in corresponding value fields are the same and are not repeated in each value field 360. In some embodiments the times for property 321b are different from the times for property 321a. For properties that do not have a values that changes in time, or for properties in which time changes between values are implicit, time is absent from the value field 360.

In some embodiments, the instance includes one or more relationship fields 371a, 371b or others indicated by ellipsis, collectively referenced hereinafter as relationship fields 371. The relationship field 371 holds data that indicates a relationship between the current instance and a different instance of the same or different concept. The relationship field 371 holds data that indicates the other instance (e.g., by concept ID and instance number) and the relationship type (e.g., patient of, or clinician for) and the property of the other instance for which the current instance provides the relationship. In the illustrated embodiment, relationship types include actor on, experiencer of, recipient of, patient of, clinician for, advisor for, evaluator of, intervening mentor for, test for, procedure on, belongs to, a member of, descriptive of, viewed by, model for, lexicon for, memory for, among others. For example an instance of a virtual mentor is an advisor for an instance of a real clinician for which the real clinician serves as a value of the property advisee. As another example, an instance of a patient chart (described in more detail below) belongs to a real clinician and is descriptive of an instance of an actual patient and is viewed by a virtual mentor.

Since the concept is language independent, the link to any natural language is mediated by a lexicon. Each lexical sense specifies which concept, concepts, property or properties of concepts defined in the ontology are instantiated in a text-meaning representation (TMR) to account for the meaning of a given lexical unit of input. For example, the English lexicon indicates that one sense of the lexical unit dog maps to the concept dog (a type of canine); another sense maps to human, further specified to indicate a negative evaluative; and yet another sense maps to the event pursue.

Lexical senses for argument-taking words and modifiers are presented along with their typical syntactic configurations. The syn-struc zone indicates the expected syntactic configuration, whereas the sem-struc zone indicates the meaning of a head word, its semantic relationship to the other elements of the structure, and any necessary constraints on other elements of the structure. Variables ($var1, $var2, etc.) are used to link the corresponding elements in the syn-struc and sem-struc zones.

For example, the text “I have a cold” is processed as follows. The syn-struc says that this is a transitive sense—i.e., the verb requires both a subject (referred to as $var1) and a direct object ($var2). The sem-struc indicates that the animal being realized by $var1 is the experiencer of the event realized by $var2. The system knows that $var1 must be an animal and $var2 must be an event because the ontological description of the property experiencer includes these constraints. The sem-struc also includes the constraint that $var2 must be not just an event, but specifically a medical-event. If an input meets both the syntactic and the semantic expectations of this sense, then this sense offers a candidate interpretation of the input. To summarize, the OntoSem lexicon supports the combined syntactic and semantic analysis of texts, and the metalanguage of description in the sem-strucs of lexicon entries is identical to that used in the ontology. For more on the lexicon and ontology, see McShane, M., Nirenburg S, Beale S., “Meaning-centric language processing,” Technical report #01-12. Institute for Language and Information Technologies, University of Maryland Baltimore County, 2012; and McShane M, Nirenburg S, Beale S., “An NLP lexicon as a largely language independent resource,” Machine Translation v19, no. 2, pp 139-73, 2005.

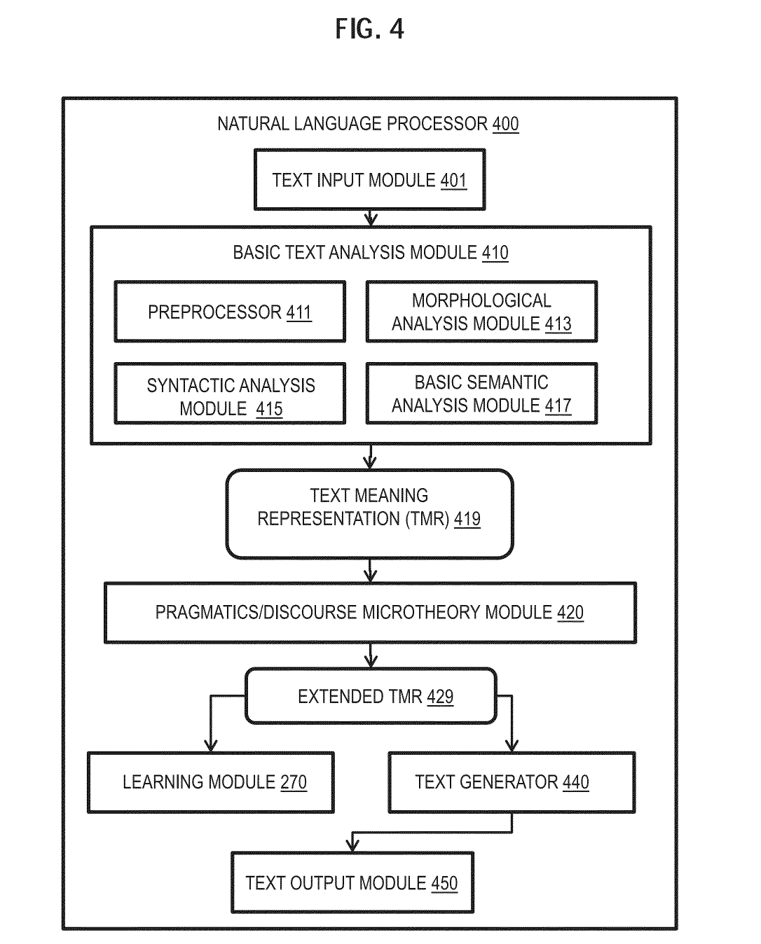

Text processing is carried out by the OntoSem text analysis system. FIG. 4 is a block diagram that illustrates an example natural language processor 400, according to an embodiment. This gives a top-level architecture of a text analysis system, e.g., used in module 220 of reasoning engine 200 or natural language processing (NLP) engine 104. The processor 400 includes a text input module 401 and a basic text analysis module 410 that outputs a text meaning representation (TMR) 419. A pragmatics and discourse microtheory module 420 further processes the TMR 419 to output an extended TMR 429. The extended TMR 429 is passed to the learning module 270 of reasoning engine 200. To generate text, the basic text analysis module outputs TMR 419 that is further processed by the module 420 to output extended TMR 429 that is passed to a text generator module 440, which outputs the text to a text output module 450. The text is then delivered by the module 450 to a real person, or to an agent representing the real person, or to a virtual agent, or some combination (e.g., to a real trainee and a virtual mentor). In the illustrated embodiment, the basic text analysis module 410 includes a preprocessor 411, a morphological analysis module 413, a syntactic analysis module 415 and a basic semantic analysis module 417.

To illustrate how intelligent agents carry out text understanding using processor 400, the processing of a sentence is described. This sentence is also used as part of a more extended example of inconsistency detection. The sentence is “Are you having any side effects?” and a virtual patient advantageously understands this sentence based on the VP's lexicon, the VP's own psychological profile and the VP's model of the psychological profile of the real or virtual clinician asking the question. Furthermore, in some embodiments, the VP responds appropriately to this question based on the VP's lexicon, plans and goals and psychological profile. This description is an encapsulation of several chapters of McShane 2012, cited above. This description assumes background knowledge of NLP; and is intended to describe for those of ordinary skill how agents understand text in processor 400.

The preprocessor 411 tokenizes the text from input 401, then, for each word, the morphological analyzer determines the part of speech (PoS), root and morphological features (not listed), as shown in Table 1. Phrasal entries, like “side effect”, are recognized as a complex root word since they are recorded as such in the OntoSem lexicon.

TABLE 1
Select results of preprocessing and morphological analysis.

| Word # | String | Part of speech | Root |
|---|---|---|---|
| 0 | Are | aux (auxiliary) | be |
| 1 | you | n (noun) | you |
| 2 | having | v (verb) | have |
| 3 | any | det | any |
| 4 | side effects | n (noun) | side.effect |
| 5 | ? | punct (punctuation) | ? |

The syntactic analysis module 415 uses the Stanford parser (see M. de Marneffe, B. MacCartney, CD Manning, “Generating typed dependency parses from phrase structure parses,” In: Proceedings of The fifth international conference on language resources and evaluation (LREC 2006). Distributed on CD by ELRA, Paris, France. 2006) to generate a syntactic dependency analysis, called herein actual dependencies—i.e., dependencies from the actual input sentence—to distinguish them from expected dependencies recorded in the OntoSem lexicon for words that take arguments. The actual dependencies for the example sentence are as follows: aux(having-2, Are-0) nsubj(having-2, you-1) det(side effects-4, any-3) dobj(having-2, side effects-4) punct(having-2,?-5)

The syntactic analysis module 415 also compiles a list of lexically-encoded expected dependencies for each lexical sense of each argument-taking word in the input. For example, for each transitive sense of a verb (like have, v7 above), the module extracts from the lexicon the following expected dependency structure: subject $var1; v $var0; directobject $var2. The analyzer then converts each expected dependency structure from the OntoSem lexicon into a Stanford-compatible format, like the following for the transitive, have-v7 example: nsubj($var0, $var1); dobj($var0, $var2). This format permits more direct comparison between the actual dependency structure for the input sentence (generated by the Stanford parser) and the expected dependency structure for each argument-taking candidate word sense listed in the OntoSem lexicon. At this point, the analyzer aligns the actual dependencies from the Stanford parse with the expected dependencies from the OntoSem lexicon and scores each alignment. For “have” from the example input sentence, all senses of “have” that have a transitive syn-struc are treated in the same way and receive the same Stanford-OntoSem linking score. The alignment is straightforward, with $var1 binding to you-1, and $var2 binding to side effects-4. To summarize, the goal of this step is to generate an exclusively syntactic score (since the Stanford parser can only weight in about syntax) for each OntoSem sense of each argument-taking word in the input sentence. This syntactic score is later combined with a semantic score to yield the best overall analysis of the text.

All lexical senses that achieve a given scoring threshold based on their syntactic alignment with the Stanford dependency parse, are then passed on to the basic semantic analysis module 417 to be scored based on the semantic constraints recorded in the OntoSem lexicon and ontology. In some embodiments, the basic text analysis module 410 includes, e.g., in module 417, a constraint optimization engine called Hunter-Gatherer (described in Beale S. “Hunter-gatherer: applying constraint satisfaction, branch-and-bound and solution synthesis to natural language semantics,” In: Technical report, MCCS-96-289, New Mexico State University, Computing Research Lab, 1996), which combines the syntactic and semantic scores of all candidate word senses and selects the optimal combination.

The output of text analysis is a text meaning representation (TMR) 419 that is written in the metalanguage of concepts of OntoSem, as described above. The content of a given TMR is generated by combining the sem-struc representations of the lexical senses selected to convey the meaning of each word in the sentence. Each TMR frame is headed by an instance of an ontological concept. For example, the TMR for the example sentence is expressed as the following instances of OntoSem concepts: REQUEST-INFO, theme=EXPERIENCER-1, textstring=?, from-sense=?-punct1; EXPERIENCER-1, DOMAIN=SIDE-EFFECT-1, RANGE=HUMAN-1, TIME=FIND-ANCHOR-TIME=indicates present tense, textstring=have, from-sense=have-v7; SIDE-EFFECT-1, DOMAIN-OF=EXPERIENCER-1, reference-action=block-coreference; HUMAN-1, EXPERIENCER-OF=SIDE-EFFECT-1, textstring=you, from-sense=you-n1.

TMR frames contain both content-bearing semantic elements and metadata. The content-bearing elements are instances of ontological concepts, written in small caps and followed by disambiguating numerical indices as instance numbers. The metadata includes the textstring slot, filled by the string that spawned the TMR frame, and the from-sense slot, filled by the lexical sense used for the interpretation. The disambiguation decision for “have” was described above. Here is described the disambiguation of other elements of the example input.

Question marks are treated like argument-taking words, being supplied with lexical entries that contain syntactic and semantic expectations for the question mark's “dependents”. The question-mark sense used for this input is described as participating in a structure with a clause-initial auxiliary—such that the syntactic dependencies of the auxiliary are accommodated by this lexical sense as well. There is only one lexical sense for the word side effect, which maps to the concept SIDE-EFFECT, a descendant of MEDICAL-EVENT. The meaning of “any” is not rendered as an ontological concept; instead, this word triggers a procedural semantic routine that blocks the search for a coreferential antecedent for side effects. Procedural semantic routines are encoded in the lexicon and run by the pragmatic and discourse microtheory module 420, and output extended TMRs 429.

The important (as determined by the application) aspects of text meaning representations in extended TMR 429 are remembered by agents in their fact repository 141 at learning module 270, which is the memory of assertions. Among the main differences between raw text meaning representations (TMR) 419 and extended TMR 429 put into the fact repository entries 141, is that the fact repository reflects the results of reference resolution. For example, if a given instance of side-effect is referred to many times, there will be one fact repository “anchor”—say, side-effect-fr8—that will be the locus of all of the information about that event derived from all of the individual, coreferential text meaning representation frames.

Text generation by an agent follows a related process from meaning in the metalanguage to semantic expressions in the lexicon of the agent to a syntactic arrangement of expression to morphing into the forms appropriate for the expression's place in the sentence. The text generation process is described in more detail in McShane et al., 2012, cited above, and S. Nirenburg, and V. Raskin, Ontological semantics, The MIT Press, Cambridge, Mass., 2004. In the illustrated embodiment, text generation is performed by module 440 with output to other real or virtual agents by way of module 450.

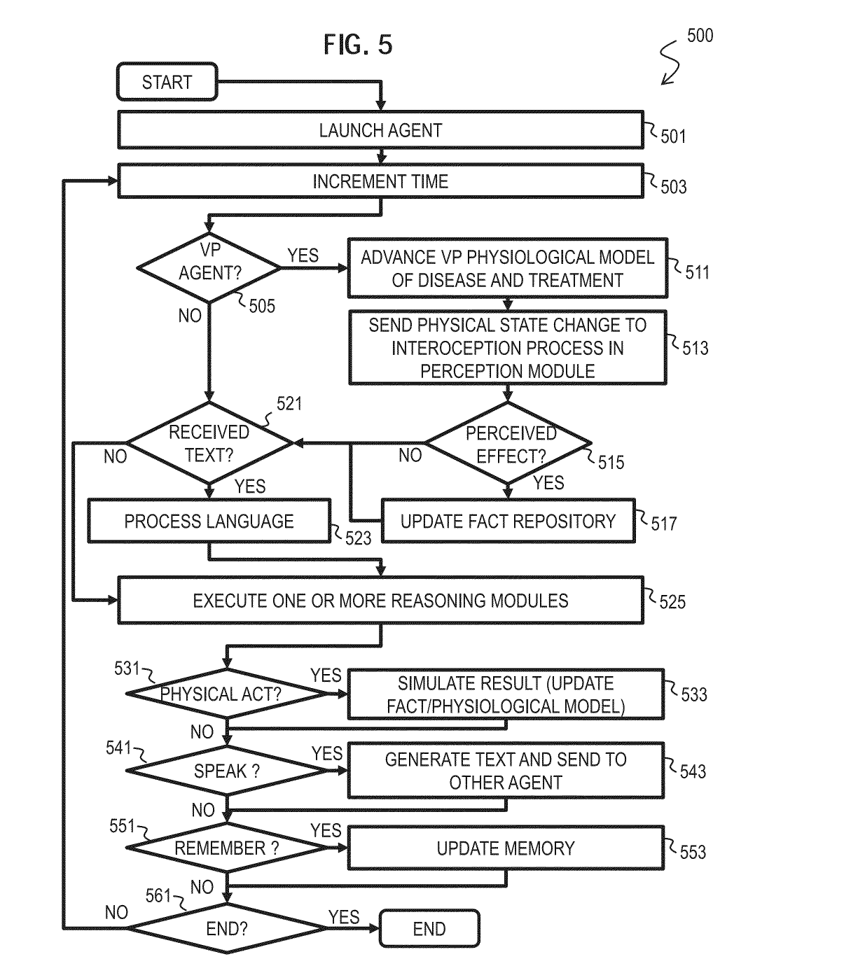

FIG. 5 is a flow chart that illustrates an example method 500 for simulating an independently reasoning agent 110 in the system 100, according to an embodiment. Although steps are depicted in FIG. 5, and in subsequent flow charts, as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

In step 501, an independently reasoning agent is launched. For example, an instance of a virtual patient is generated, or an instance of a virtual mentor is generated, or an instance of a virtual clinician (trainee or otherwise) is generated. The system may also launch multiple agents in any combination, but method 500 is focused on what a single independently reasoning agent does.

In step 503, time is incremented for the agent. The time step can be short, e.g., representing the seconds after a clinician has generated text during a dialog, or long, such as the time for a disease to express symptoms that are perceptible in a virtual patient. The appropriate size of the time increment is determined during step 503 based on the type of agent and the purpose of the simulation for the system 100.

In step 505 it is determined whether the agent is a virtual patient or other agent that includes a physiological module 130. If not, control passes to step 521, described below. If so, then control passes to step 511 and step 513 and step 515. In step 511, the physiological model implemented in the physiological module 130 is incremented in time to simulate the progression of the medical state of the agent. For example, a disease imparted to the instance of the virtual patient progresses according to the script that simulates that disease, as described in more detail below for a particular example disease achalasia. In step 513. The physical state change that occurs over the time step is sent to the interoception process, e.g., interoception module 212, in the perception module 210. The interoception process thus perceives physiological stimuli generated by the physiological module 130.

In step 515 the interoception process determines whether the change in state is perceptible to the agent, e.g., whether the effect exceeds some threshold or otherwise enters some perceptible range. In some embodiments, the threshold or range is a population average. In some embodiments, the threshold or range is based on the personality traits of the agent, as described in more detail below. If the effect enters the perceptible range, then in step 517, the agent's memory 141 in the fact repository 140 is updated so the agent can remember the perceived effect. In either case, control passes to step 521. In some embodiments, the interoception module 212 operates a set of demons that are programmed (a) to notice the changes in values of specific physiological parameters and (b) if these values move outside a certain range, to instantiate corresponding symptoms in the VP's memory 141. Symptoms are represented as values of properties in the VP's profile of self, which is an instance of the ontological concept human stored in its fact repository.

In step 521, it is determined whether the agent has received text, e.g., from a real person or from another agent. If not, control passes to step 525 described below. If so, then in step 523 the text is subjected to natural language processing, e.g., by NLP engine 104 or by deep language processing module 220, described above. The result of step 523 is the meaning of the text received, e.g., in one or more TMRs or extended TMRs.

In step 525, one or more reasoning modules are executed for the agent. For example, the agent takes meaning from received text via module 220, if any, and facts from the agent's memory 141 via module 230, including any symptoms perceived during step 515 and stored during step 517, and including any model for the psychological profile of a different agent, if any, with whom the agent is interacting. This information is combined with the agent's goals and plans from module 240 and traits and preferences from module 260 by the decision making module 250 to determine what action the agent will take next. Thus in some embodiments, the decision is based, at least in part, on the personality traits included among an agent's psychological profile data. As a consequence, simulation output from the system is based at least in part on the psychological profile data.

If it is determined in step 531 that the decided action is to perform some “physical” act in the world being simulated, such as taking medicine or starting exercise, then in step 533 the result of that physical act is simulated, e.g., in one or more of action modules 280. For example the physiological module is updated with the event of taking the medication or the fact repository is updated to show a visit with a specialist is scheduled for a particular date.

If it is determined in step 541 that the decided action is to convey some meaning to another agent (i.e., speak), then in step 543 the text to convey that meaning in the lexicon of the agent is generated, e.g., by having modules 280 submit that meaning to the deep language processing module 220 to generate text from the meaning. In some embodiments, the module 280 receives the generated text from the module 220 and directs the generated text to the proper other agent, also during step 543. For example, in some embodiments a virtual clinician tells a virtual patient to undergo a certain medical procedure. In some embodiments a virtual mentor tells a practicing or trainee clinician that a diagnosis applies to a real or virtual patient.

If it is determined in step 551 that the decided action is to remember something, such as a medical procedure taken (e.g., taking medicine) or something said by another agent, or some evaluation of the other agent based on comparison to standards, then, in step 553, memory 141 is updated, e.g., by one or more action modules 280 invoking learning module 270.

Thus, using the method 500, an independently reasoning virtual agent interacts with one or more agents in a medical clinical information processing system configured to simulate interactions between a clinician and a patient. As described in more detail below, in some embodiments, the agent represents a virtual patient, the system 100 receives input from a clinician trainee, and the simulation output indicates a response of the virtual patient to the input by the trainee. In some embodiments, the agent represents a real or virtual clinician, the system 100 receives input from the clinician, and the simulation output indicates an evaluation of the clinician. In some embodiments, the agent represents an actual patient, a different agent represents a virtual mentor, the system 100 receives input from a clinician, and the simulation output indicates a recommended diagnosis or procedure for the actual patient by the virtual mentor. In some embodiments, the agent represents an actual patient, a different agent represents a virtual mentor, the system 100 receives input from a clinician, and the simulation output indicates an evaluation (such as a personality trait) of the actual patient by the virtual mentor.

### 2. Example Virtual Patient

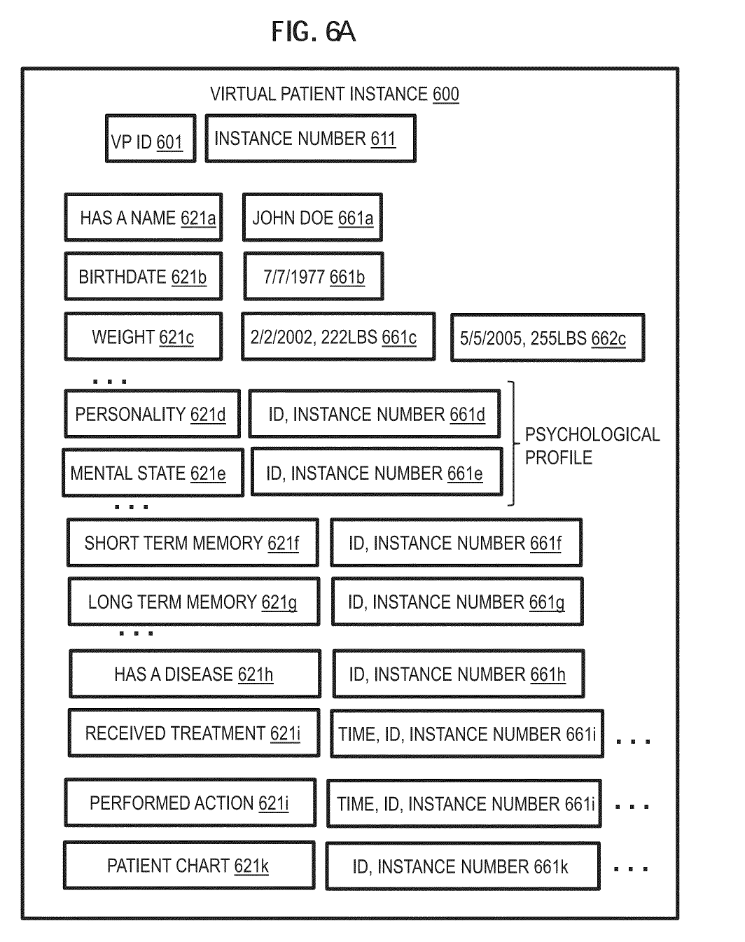

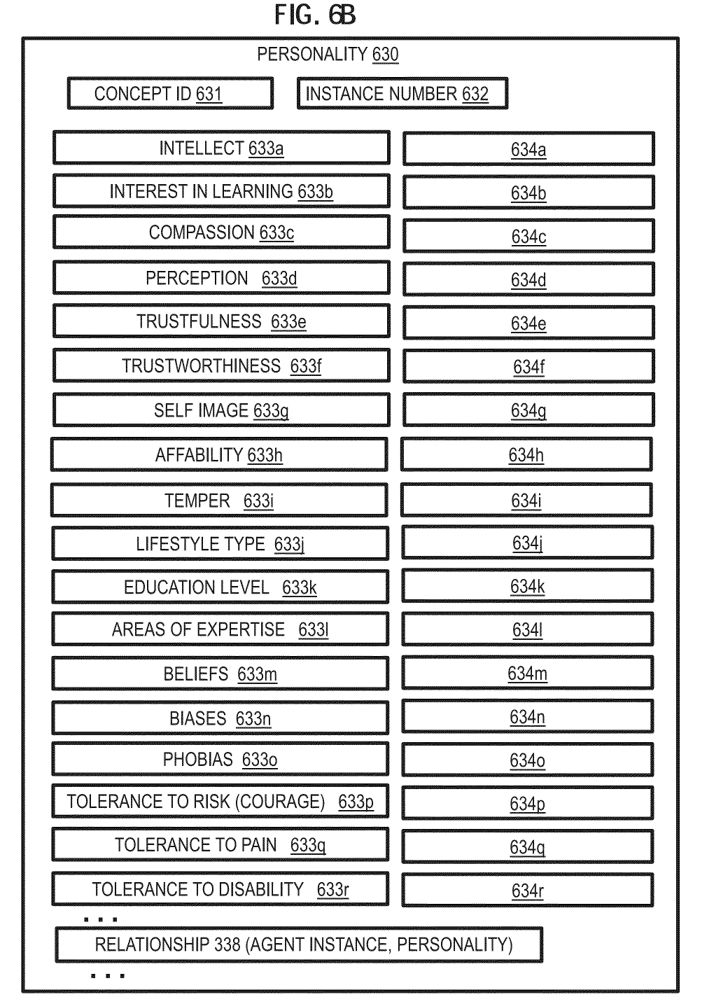

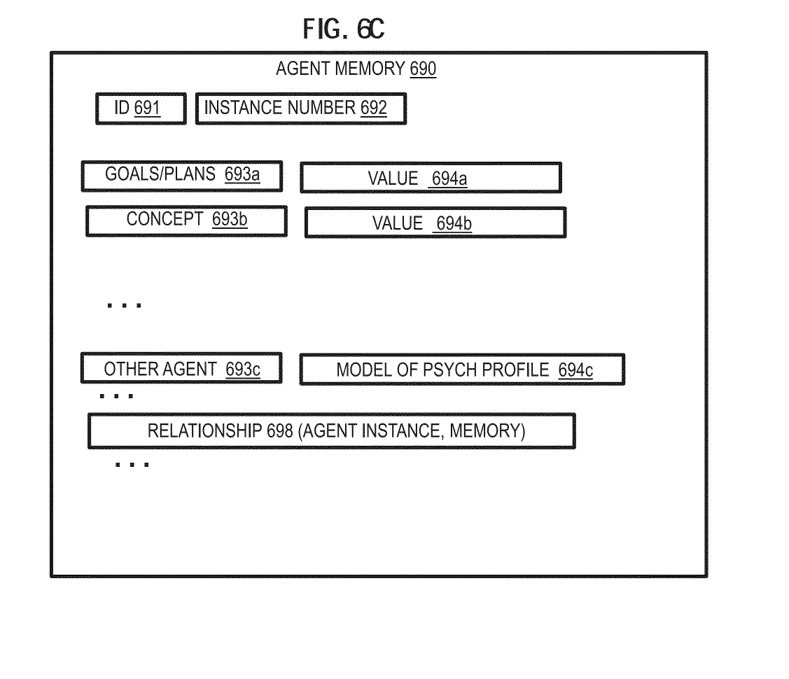

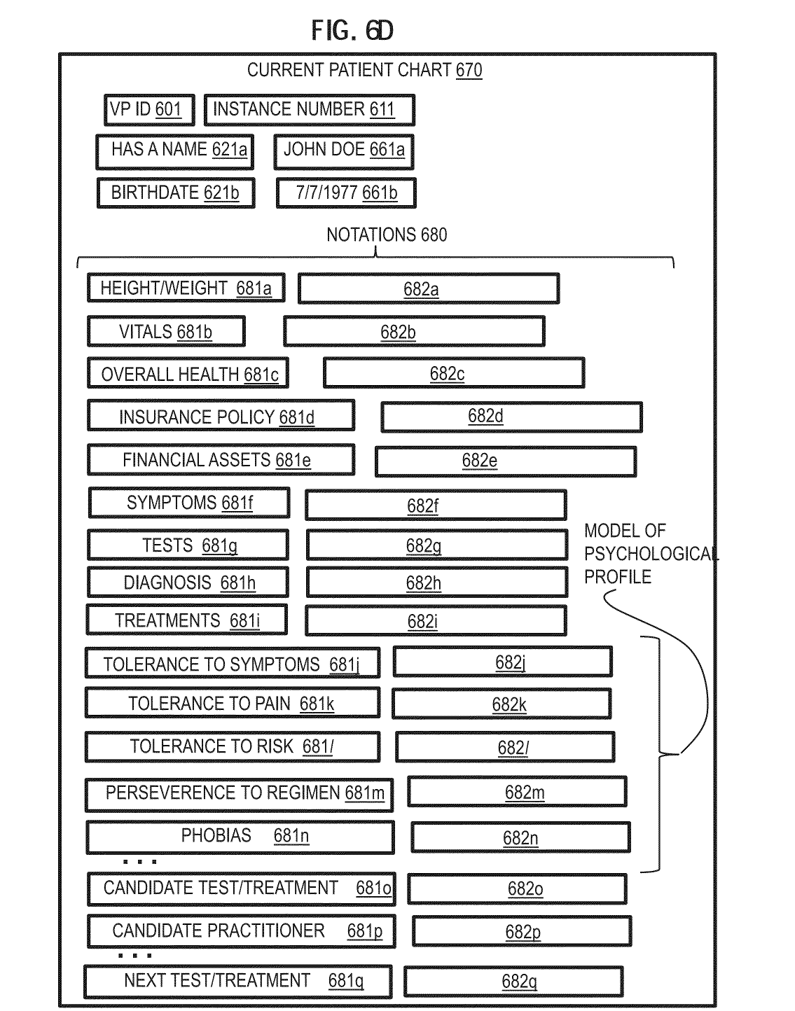

FIG. 6A is a block diagram that illustrates an example instance 600 of a virtual patient agent (called simply a virtual patient, VP, hereinafter) in the hierarchical data structure, according to an embodiment. The VP instance 600 includes a VP concept ID field 601 and an instance number field 611, the combination uniquely identifying the instance of the virtual patient. In the illustrated embodiment, the VP properties include the patient's name, birthdate, weight, height, gender, eye color and other physical characteristics that differ among persons. These properties are indicated in the example fields including the has_a_name field 621a, birthdate field 621b and weight field 621c among other indicated by ellipsis. As an instance of a virtual patient, there is a specific value associated with each property at one or more times. For example, associated with has_a_name property field 621a there is a value field 661a that holds data indicating the name “John Doe” with no time mark because this value is constant in time. Similarly, associated with birthdate field 621b there is a value field 661b holding data that indicates the date Jul. 7, 1977 with no time mark. Associated with weight field 621c there are two value fields 661c, 662c holding data that indicates the weights 222 pounds (lbs) and 255 lbs, respectively, at time marks Feb. 2, 2002 and Feb. 5, 2005, respectively, corresponding to weights on different visits to the clinic.

In some embodiments, the values for one or more properties are specific values, e.g., to create a virtual patient that has a certain disease to be diagnosed by a clinician trainee. In other embodiments, the values for a virtual patient are generated from the statistics of a population represented by the patient. In some embodiments, the virtual patient represents imperfect knowledge about a real patient, and the values are a default value or average value or a range or subrange of values appropriate for a population to which the patient belongs (e.g., by age, gender and general health or condition). The range is narrowed as more is learned about the real patient. For example, the values for a virtual patient representing a real patient are filled using: a virtual mentor's ontological knowledge of patients and diseases; probability distributions formulated at the level of populations; and whatever information the clinician gathers over time about the real patient, through patient interviews, tests, and treatments.

In the illustrated embodiment, the properties of a virtual patient include personality traits and mental states that together constitute psychological profile data indicated in personality field 621d and mental state field 621e, respectively. In the illustrated embodiment of the instance of the VP, the value for each of these properties, given in fields 661d and 661e, respectively, is an instance of a personality trait concept and an instance of a mental state concept, each indicated by a concept ID and instance number. The mental state instance give values for one or more properties such as stress level, defensiveness and alertness, as described above, among others. An example personality instance is described in more detail below with reference to FIG. 6B. The values of the psychological profile data are used in various embodiments to simulate actions of the VP and reactions of the VP to dialog and perception of external and internal conditions, such as contribute to interoception. In some embodiments, the values of the psychological profile data for an agent such as a VP, a real clinician, a trainee, or a virtual clinician are determined based on observation of actions and reactions by those agents or used to evaluate an agent, or some combination. In various embodiments, evaluation of an agent includes evaluating performance of a clinician or evaluating the medical state of a patient or evaluating personality of an agent, or some combination. As used herein personality evaluation includes determining one or more personality traits or mental states of the agent, such as an agent representing a real patient or an agent representing a clinician or an agent representing a clinician trainee. Performance evaluation includes determining accuracy or efficiency of proposed hypothesis or proposed diagnosis or proposed testing or proposed treatment.

In the illustrated embodiment, the properties of a virtual patient include short term memory and long term memory that together constitute agent memory indicated in short term memory field 621f and long term memory field 621g, respectively. In the illustrated embodiment of the instance of the VP, the value for each of these properties, given in fields 661f and 661g, respectively, is an instance, e.g., 141c, of a memory concept in the fact repository, each indicated by a concept ID and instance number.

In the illustrated embodiment, unlike such agents as virtual clinicians and virtual mentors, the properties of a virtual patient include one or more diseases and treatments indicated in has_a_disease field 621h and received_treatment field 621i, respectively. In the illustrated embodiment of the instance of the VP, the value for each of these properties, given in fields 661h and 661i, respectively, is an instance of a disease concept and a treatment concept, respectively, from the medical knowledge base 150, each indicated by a concept ID and instance number. Because multiple treatments can be applied to each disease, the value fields for treatments include a time mark, indicated by the word “time” in the FIG. 6A. In some embodiments, the patient's (possibly imperfect) knowledge of treatments received is stored in the instance of the long term memory of the patient.

In the illustrated embodiment, the properties of a virtual patient include one or more actions performed indicated in a performed_action field 621j. In the illustrated embodiment of the instance of the VP, the value for this property, given in field 661j, is an instance of an action concept, indicated by a concept ID and instance number. Because multiple actions can be performed, the value fields for actions include a time mark, indicated by the word “time” in the drawing. Example actions performed include the concepts for contact clinician, visit clinician, change diet, change habit, take medication, agree to procedure, communicate concept, among others. In some embodiments, the patient's (possibly imperfect) knowledge of actions performed is stored in the instance of the long term memory of the patient.

Patient charts are data structures that record medical information about a patient maintained by one or more real or virtual clinicians or mentors. In the illustrated embodiment, the properties of a virtual patient include one or more patient charts indicated in a patient_chart field 621k. In the illustrated embodiment of the instance of the VP, the value for this property, given in field 661k, is an instance of a patient chart concept, indicated by a concept ID and instance number. Typically, one chart is shared by several clinicians. Because one or more separate charts are allowed in some embodiments (e.g., to separate a patient chart kept by a virtual or real mentor from one kept by a trainee), multiple value fields for patient charts are indicated by ellipsis. An example instance of a patient chart is described in more detail below with reference to FIG. 6D. In an illustrated embodiment, the patient chart includes one or more properties and values that model the clinician's view of the psychological profile of the patient, which may imperfectly describe the patient's actual psychological profile as stored in values for properties in fields 621d and 621e, described above.

FIG. 6B is a block diagram that illustrates an example instance 630 of a personality concept for psychological profile data in the hierarchical data structure for an agent, according to an embodiment. The agent may be a virtual patient or an agent representing a real or virtual clinician in various embodiments. For example, in some embodiments, the instance of the personality concept is a model that a real or virtual mentor has of a clinician or trainee being advised or evaluated. The values of properties here affect the way the agent interacts with other agents during a simulation, e.g., in dialog or in what actions the agent is willing to take or how far the agent is willing to deviate from prior goals and plans. As with any instance, the personality instance 630 includes a concept ID field 631 holding data that indicates the concept (e.g., the personality concept) and an instance number field 632 holding data indicating a unique instance of that concept.

In the illustrated embodiment, the properties of the personality instance are indicated by fields that are described here. Although values are described with a few example values (e.g., below average, average, above average) for simplicity, in other embodiments a large range of values, such as on a scale from 0 to 5 for least to most or scale from 0 to 8 or ten from least to most, or some combination, is used. In some embodiments, one or more of these properties are omitted or other properties are added. In some embodiments, the set of properties in the personality concept or instance is different for one agent (e.g., representing a patient) from a different agent (e.g., representing a clinician).

An intellect field 633a holds data that indicates an intellect property, a primitive, and the value field 634a holds data that indicates a value, e.g., about average, substantially above average, substantially below average or a numeric intelligence quotient (IQ) value for the agent. An interest_in_learning field 633b holds data that indicates an interest in learning property, a primitive, and the value field 634b holds data that indicates a value, e.g., about average, substantially above average, substantially below average willingness to learn new things. An education_level field 633k holds data that indicates a level of formal education property, a primitive, and the value field 634b holds data that indicates a value, e.g., grade level or list of degrees conferred. One or more of these properties is advantageous in some embodiments for determining the extent to which a condition or procedure can be explained to a patient.

A compassion field 633c holds data that indicates a compassion property, a primitive, and the value field 634c holds data that indicates a value, e.g., about average, substantially above average, substantially below average ability to show compassion for other humans. An areas_of_expertise field 6331 holds data that indicates a property for medical areas of expertise, a primitive, and the value field 6341 holds data that indicates a value, e.g., a list of medical disciplines, such as cardiology, neurosurgery, among others. One or more of these properties is advantageous in some embodiments for simulating a patient response to a suggestion by a clinician with such properties.

A perception field 633d holds data that indicates a perception property, a primitive, and the value field 634d holds data that indicates a value, e.g., about average, substantially above average, substantially below average ability to notice internal symptoms and environmental changes. A trustfulness field 633e holds data that indicates a trustfulness property, a primitive, and the value field 634e holds data that indicates a value, e.g., about average, substantially above average, substantially below average tendency to believe the assertions stated by others. A trustworthiness field 633f holds data that indicates a trustworthiness property, a primitive, and the value field 634f holds data that indicates a value, e.g., about average, substantially above average, substantially below average tendency to accurately represent want the agent decides, knows or remembers. A self image field 633g holds data that indicates a self image property, a primitive, and the value field 634g holds data that indicates a value, e.g., about average, substantially above average, substantially below average image of self held by the agent. One or more of these properties is advantageous in some embodiments for determining how much information is in a patient's memory and how much of that the patient is willing to reveal.

An affability field 633h holds data that indicates an affability property, a primitive, and the value field 634h holds data that indicates a value, e.g., about average, substantially above average, substantially below average tendency to be perceived as friendly and easy to talk with. This property is advantageous in some embodiments for evaluating a clinician's ability to extract disclosures from a patient. A temper field 633i holds data that indicates a temper property, a primitive, and the value field 634i holds data that indicates a value, e.g., about average, substantially above average, substantially below average tendency to react with anger and lose rationality in response to disagreement or bad news. This property is advantageous in some embodiments for simulating responses from a patient with a serious condition.

A lifestyle_type field 633j holds data that indicates a lifestyle type property, a concept that includes one or more properties to describe eating, exercise, work or drug habits, among others, alone or in some combination. The value field 634j holds data that indicates a particular instance. This property is advantageous in some embodiments for prescribing a lifestyle change suitable for a patient.

A beliefs field 633m holds data that indicates a beliefs property, a concept that includes one or more properties to describe one or more conscious effects of an agent based on particular experiences by that agent that cause an agent deviate from the standard knowledge in the knowledge database, such the usefulness of medication or being under a physician's care. The value field 634m holds data that indicates a particular instance. For example, in some embodiments, beliefs involve: noteworthy aspects of other agents' ontologies (e.g., “the doctor has a large medical supplement that I don't have”); the agent's own beliefs about others' beliefs (“the doctor thinks I'm lying”); the agent's assumptions about the decision-making processes of others (“the doctor is telling me to do surgery because he is a surgeon and has a bias toward surgery”); and, the agent's interpretation of others' character traits (“the doctor is compassionate and has my best interests at heart”). All of these can affect decision-making in ways that are discussed below

A biases field 633n holds data that indicates a biases property, a concept that includes one or more properties to describe one or more biases of an agent, which are subconscious effects that cause an agent to make decisions not supported by the evidence presented. The value field 634n holds data that indicates a particular instance. In various embodiments, different biases are used for different agents.

For example, in some embodiments, real or virtual patient biases include the exposure effect, the effect of small sample, the effect of evaluative attitudes, depletion effects, halo effects and nature of dialog with a clinician. The exposure effect arises because modern-day patients are barraged by drug information in advertising over various media, sometimes with lengthy warnings. From this, the patient's impression of the medication might involve an overly positive impression or, in contrast, a vague but lengthy inventory of side effects that the doctor did not mention, and these might serve as misinformation in the inventory of parameters used in the patient's decision function. The effect of small samples arises because the patient might know somebody who took this medication and had a bad time with it, and the patient generalizes from the experience that it is a bad drug, despite the doctor's description. The effect of evaluative attitudes arises because the patient might not like the idea of taking medication at all, or the patient might not like the idea of some class of medications due to a perceived stigma (e.g., against antidepressants), or the patient might be so opposed to a given type of side effect that its potential overshadows any other aspect of the drug. The depletion effects arise because the patient might be tired or distracted or otherwise stressed when making a decision, so that: the patient might consider saying ‘no’ to be the least risk option; or fatigue might have caused lapses in attention so that the patient misremembers the clinician's description of a procedure.

In some embodiments, the patient biases include a positive and negative halo effect, which is the tendency to assess a person positively or negatively in all circumstances on the basis of just a few known positive or negative features. On the one hand, a patient might like a clinician so much that the patient agrees to the latter's advice before learning a sufficient amount about it to make a responsible, informed decision. On the other hand, the patient might dislike the doctor so much that the patient refuses advice that would actually be in the patient's interest because the patient generalizes that a “bad” doctor must be giving bad advice. Extending the halo effect to events, a patient might be so happy that a procedure has few risks that the patient assumes that the procedure won't hurt and will have no side effects—both of which might not be true. By contrast, the patient might be so thrown by the fact that the procedure will hurt that the patient exaggerates the patient's impression of the procedure's risk or loses sight of the procedure's potential benefits. In various embodiments, virtual mentors are programmed to evaluate, advise or teach real or virtual clinicians to detect halo effects in order to ensure that the patient is making the best, most responsible decisions for the patient. It is no better for a patient to blindly undergo surgery because the patient likes a clinician than it is for a patient to refuse life-saving surgery because the patient is angry with the clinician.

The nature of the dialog introduces biases because the way a situation is presented or a question is asked can strongly impact a patient's perception and subsequently affect the patient's related decision making. For example, if a patient is asked “Doesn't something hurt right now?” the patient will have tendency to seek corroborating evidence—something that actually hurts a little. This is called the confirmation bias. If a patient is asked, “Your pain is very bad, isn't it?” the patient is likely to overestimate the level of pain because the patient has been primed with a high pain level. This is called the priming effect, or priming bias. Telling a patient that “There is a 20% chance this will fail,” causes the patient's perception to be more negative than telling the patient, instead, “There's an 80% chance this will succeed.” This is called the framing sway, or framing bias. An agent's susceptibility to these biases is included in the biases concept indicated by field 633n, in some embodiments.

In some embodiments, biases are associated with a real or virtual clinician. There are typically two stages to diagnosing a patient. First, based on a patient interview and physical examination, the clinician posits a hypothesis that the clinician then attempts to confirm either through medical testing or trial therapy (e.g., medication, lifestyle change). Confirming a hypothesis by testing leads to a definitive diagnosis, while confirming a hypothesis by successful therapy leads to a clinical diagnosis. Unintentionally biased decision-making by the clinician can happen at any point in this process, and should be detected by a real or virtual mentor during training, advising and evaluation of clinicians. Several types of clinician biases are included in various embodiments, including: the need for more features bias; jumping to conclusions bias; false intuition bias (including base rate neglect bias and small sample bias); and the illusion of validity bias (including the exposure effect bias).

The need more features bias arises when a clinician thinks that a decision will benefit if more variables are considered to personalize or narrowly contextualize the decision. A clinician is characterized by the clinician's propensity for this tendency to look for more tests and results before reaching a decision on a hypothesis or diagnosis. Jumping to conclusions bias arises when a clinician posits a diagnosis prior to having the full set of values. In some respects, the jumping to conclusions bias is the opposite bias to the need more features bias. In some embodiments skilled intuition is defined as recognition of a constellations of highly predictive parameter values based on sufficient past experience. False intuition bias arises when a clinicians acts as though parameters are predictive without the experience desirable to justify that conclusion. False intuition bias includes base-rate neglect and small sample bias. Base-rate neglect is a type of decision-making bias that, applied to clinical medicine, can refer to losing sight of the background frequency of a disease for a given type of patient in a given circumstance. The small sample bias arises when a clinician's understanding of the frequency or likelihood of an event is swayed from objective measures by the clinician's own experience, and by the ease to which an example of a given type of situation—even if objectively rare—comes to mind. The small sample bias can lead to placing undue faith in personal experience in contrast to larger population studies. The illusion of validity bias describes a clinician's clinging to a belief despite evidence that it is unsubstantiated. The exposure effect bias describes people's tendency to believe in, or at least rely on, frequently-repeated falsehoods due to familiarity.

A phobias field 633o holds data that indicates a phobias property, a concept that includes one or more properties to describe one or more irrational fears by an agent, such as heightened fears of needles, confined spaces, crowds or other conditions. The value field 634o holds data that indicates a particular instance. This field is advantageous to realistically simulate the response of a patient to suggested procedures, for example the negative response of a patient with claustrophobia to a suggestion for an magnetic resonance imaging (MRI) procedure, no matter how useful.

A courage field 633p holds data that indicates a courage property, a primitive that indicates a patient's tolerance to risk (uncertainty in results). The value field 634p holds data that indicates a value, e.g., about average, substantially above average, substantially below average tolerance to risk. This field is advantageous to realistically simulate the likelihood a patient will agree to be subjected to a procedure with uncertain results. Similarly, pain tolerance field 633q holds data that indicates a pain tolerance property, a primitive that indicates a patient's tolerance to pain. The value field 634q holds data that indicates a value, e.g., a level or pain tolerated well, a level of pain tolerated with difficulty and a level of pain not tolerated. This field is advantageous to realistically simulate the likelihood a patient reports pain or discomfort associated with a symptom or agree to a procedure that involves some level of pain. A disability tolerance field 633r holds data that indicates a disability tolerance property, a primitive that indicates a patient's tolerance to disability from symptoms or other causes of disability. The value field 634r holds data that indicates a value, e.g., substantially below average, about average or substantially above average ability to tolerate disability associated with a symptom or procedure. This field is advantageous to realistically simulate the likelihood a patient reports disability associated with a symptom or agrees to a procedure that involves some amount of temporary or permanent disability.

In the illustrated embodiment, the properties of the personality instance 630 include one or more relationships, such as relationship 338. A relationship indicates that this instance is serving as a value for a property of another instance. In the example, the value of relationship 338 is that the personality instance serves as descriptive of or model for the personality of an instance of an agent.

FIG. 6C is a block diagram that illustrates an example instance 690 of memory in the hierarchical data structure for an agent, according to an embodiment. As with any instance, the agent memory instance 690 includes a concept ID field 691 holding data that indicates the concept (e.g., the agent long term memory concept) and an instance number field 692 holding data indicating a unique instance of that concept. In the illustrated embodiment, the properties of the agent memory instance include a goals/plans property field 693a and value field 694a. In the illustrated embodiment, the goals/plans property refers to a concept that describes the agent's goals and plans with an instance indicated in field 694a. For example, for a clinician, a goal is to know patient symptoms and the associated plans include request info (i.e., ask a question), physical exam, detect lying, pursue lying-hypothesis, among others, alone or in combination. Another goal is to collaborate with patient, and the associated plans include show empathy, explain questions, learn patient priorities, learn patient biases and learn patient phobias, among others, alone or in combination. Another goal is to achieve effective treatment and the associated plans include consult knowledge base and seek expert advice. For a virtual mentor that tutors a trainee, one goal is to have trainee avoid omissions and the associated plans include warn about omissions. Another goal is to provide positive feedback, and the associated plans include reinforce good bedside manner. For the patient in various embodiments, one goal is to be healthy, another goal is to avoid pain, and a third goal is to minimize cost, each with associated plans.

In the illustrated embodiment, the properties of the agent memory instance 690 include other properties, such as property field 693b for another concept and value field 694b indicating an instance, among others indicated by ellipsis. In the illustrated embodiment, the agent memory instance 690 includes a psychological profile of another agent (e.g., a virtual patient has a physiological profile for the clinician the patient interacts with, and the clinician has a psychological profile for the patient, and the mentor has a psychological profile for the clinician). The properties of the agent memory instance 690 also include one or more relationships, such as relationship 698. In the example, the value of relationship 698 is that the agent memory instance serves as memory for an instance of an agent.

FIG. 6D is a block diagram that illustrates an example instance 670 of a patient chart in the hierarchical data structure used by an independently reasoning agent that represents a clinician who is treating the patient, according to an embodiment. In some embodiments this instance is related to a patient but is filled in by a real or virtual clinician or mentor in response to a dialog with the patient and medical procedures, wherein medical procedures include medical tests and medical treatments for one or more diseases or conditions. The patient chart instance 670 includes one or more fields to identify the patient being described by this chart, such as the virtual patient concept ID in VP ID field 601 and instance number in instance number field 611. To emulate an actual patient chart for a human clinician or mentor, the fields for the properties include has_a_name field 621a with a value in field 661a, as well as one or more other properties, such as birthdate in birthdate field 621b with a value in field 661b. The remaining fields are values provided by a clinician for concepts relevant to mark patient status and progress, called notations 680 herein.

In the illustrated embodiment, the notations 680 include a height/weight field 681a, since these two attributes are typically made together. The values at specified times are given in values field 682a as primitives or instances of a concept. Similarly, the notations 680 include a vitals field 681b holding data that indicates vital signs with values at one or more times in values field 682b as primitives or instances of a concept, and an overall health field 681c holding data that indicates overall health with values, such as poor, fair, good, excellent at one or more times in values field 682c. Other properties of a patient that influences diagnosis and treatment in various embodiments are indicated, such as: insurance policy field 691d and values field 682d as primitives or instances of a concept; financial assets field 681e and values field 682e as primitives or instances of a concept; symptoms field 681f and values field 682f as instances of a concept; tests field 681g for medical tests and values field 682f as instances of a concept including status (ordered, completed) and results of various measures at each of one or more times; diagnosis field 681h for medical diagnoses and values field 682h as instances of a concept including disease and stage at each of one or more times; and, treatments field 681i for medical treatments and values field 682i as instances of a concept including status (ordered, completed) and results, such a tissue removed or medications given and doses at each of one or more times. Some embodiments include a hypothesis field and associated values in or more instances of a medical hypothesis.

In some embodiments, the notations include a model of the patient's psychological profile with clinician estimated values of the patient's tolerance to disability caused by the symptoms in fields 681j and 682j, tolerance to pain in fields 681k and 682k, and tolerance to risk (i.e., courage) in fields 681l and 682l. The clinician may also make an assessment of the likelihood the patient will persevere to a regimen of medical actions, such as lifestyle changes and medication on a prescribed schedule, using the perseverance to regimen property indicated in field 681m with values in 682m. In some embodiments this value is determined by the real or virtual clinician or mentor in view of the patient's history and responses in a dialog that reveal one or more other aspects of the patient's actual psychological profile in instance 630. Similarly, the clinician or mentor records the patient's phobias as revealed or inferred using the phobias field 681n and values field 682n. Other features of the model for the patient's psychological profile, such as beliefs and biases, revealed or inferred are indicated by ellipsis.

In the illustrated embodiment, the notations further include a field 6810 for candidate procedure (e.g., test or treatment) and field 682o for associated values, such as a name of treatment and dose, as a primitive or instance of a concept. Similarly, the notations further include a field 681p for candidate practitioner to perform the procedure and field 682p for associated values, such as a name and rating (poor, acceptable, excellent), as a primitive or instance of a concept. In the illustrated embodiment, the notations further include a field 681q for the next procedure decided upon among the candidates and field 682q for associated values, such as a name of treatment and dose, as a primitive or instance of a concept. Other fields present in some embodiments are indicated by ellipsis.

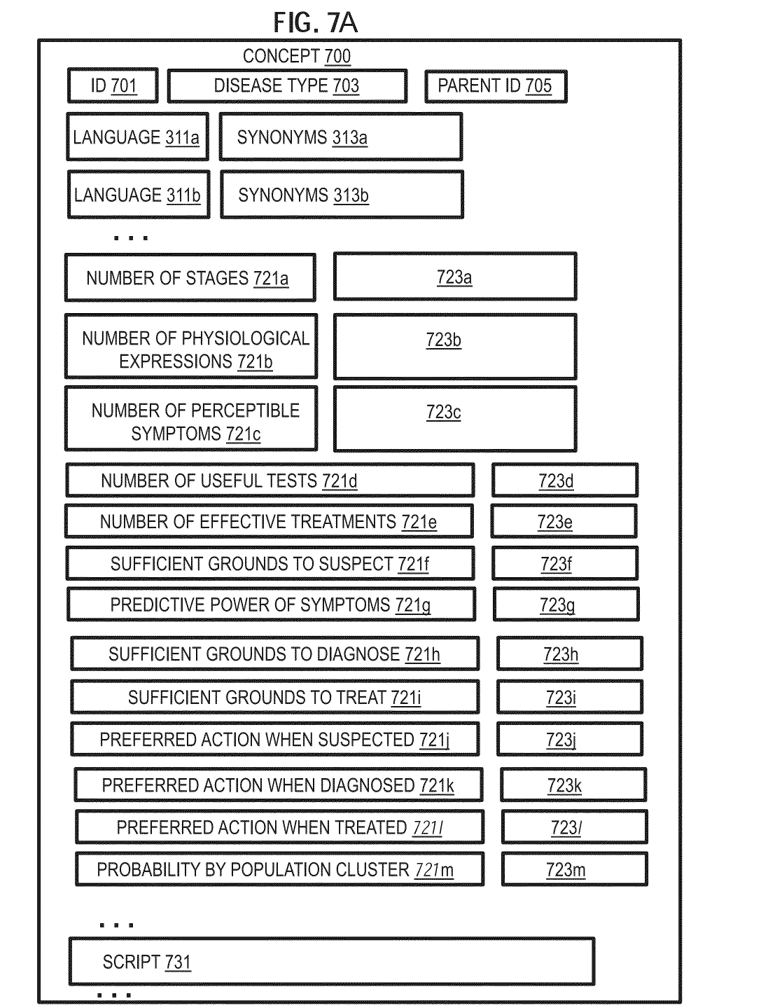

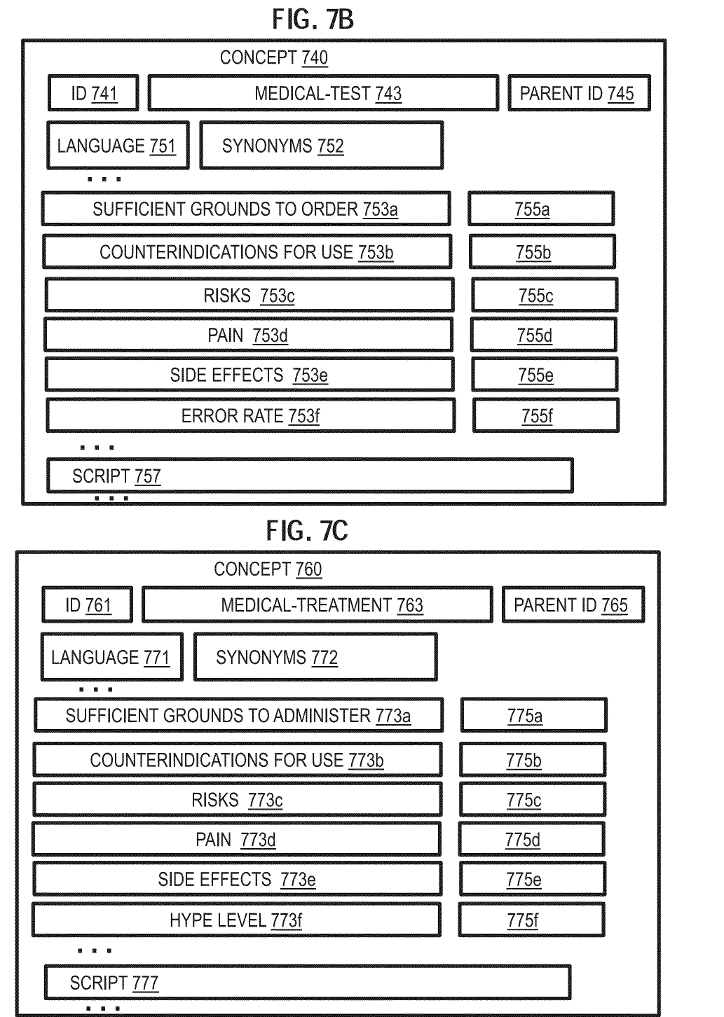

FIG. 7A is a block diagram that illustrates an example disease concept 700 in the hierarchical data structure for storing expert knowledge about a disease, according to an embodiment. The ID field 701 holds data that indicates the unique identifier for the concept. The disease type field 703 holds data that indicates the disease or family of diseases described by the properties in this concept and the parent ID field 705 holds data that indicates the parent concept from which other properties and scripts are inherited. The language and synonyms fields 311a, 311b, 313a and 313b are as described above in FIG. 3A for concepts in general. Field 731 and other fields represented by ellipsis hold data that indicates a script for the disease concept, including a script for generating an instance from the concept.

In the illustrated embodiment, the disease concept 700 includes field 721a that holds data that indicates a number of different stages of the disease for a particular disease and the constraints field 723a holds data that constrains the acceptable values for this property. The field 721b holds data that indicates a number of different physiological expressions of the disease among the different stages described and field 723b holds data that indicates the constraints. The field 721c holds data that indicates a number of perceptible symptoms of the disease among the different stages described and field 723c holds data that indicates the constraints for this property. These properties offer the advantage of providing the knowledge used to generate a virtual patient with the disease and respond properly to tests and treatments ordered by the real or virtual clinician. In some embodiments, a particular disease is modeled by a script and not by a number of stages, and in such cases the number the stages is a null value, e.g., zero.

Field 721d holds data that indicates a number of useful tests for the disease; field 721e holds data that indicates a number of effective treatments; field 721f holds data that indicates sufficient grounds to suspect; field 721g holds data that indicates predictive power of symptoms; field 721h holds data that indicates sufficient grounds to diagnose; field 721i holds data that indicates sufficient grounds to treat; field 721j holds data that indicates preferred action when suspected; field 721k holds data that indicates preferred action when diagnosed; field 721l holds data that indicates preferred action when treated; and, field 721m holds data that indicates probability of the disease by population cluster. Fields 723d, 723e, 723f, 723g, 723h, 723i, 723j, 723k, 723l, 721m, respectively, hold data that indicates the constraints on values for each property. Some of these properties are primitives and others (e.g., probability by population cluster) refer to concepts for which values are instances of the concept. These properties offer the advantage of providing the knowledge used by virtual mentors to train, advise and evaluate the actions of real or virtual clinicians. Other properties and constraints are indicated by ellipsis.

Medical procedures include medical tests and medical treatments for which concepts are defined. FIG. 7B is a block diagram that illustrates an example medical test concept 740 in the hierarchical data structure for storing expert knowledge about a medical test, according to an embodiment. The concept ID field 741, parent ID field 745, language field 751 and synonyms field 752, and fields for other languages indicated by ellipsis, are as described above for corresponding fields in other concepts. The concept name field 743 holds data that indicates a medical-test concept. Field 757 and other fields represented by ellipsis hold data that indicates a script for the medical test, including a script for generating an instance from the concept.

Field 753a holds data that indicates sufficient grounds to order the test; field 753b holds data that indicates counterindications that advise against using the test; field 753c holds data that indicates health risks to the patient, field 753d holds data that indicates a pain or discomfort level experienced by the patient during the test; field 753e holds data that indicates any side effects of the test not described by properties of fields 753b, 753c or 753d; and, field 753f holds data that indicates an error rate for the test, such as percent chance of false positive or percent change of false negative, or some combination. Fields 755a, 755b, 755c, 755d, 755e and 755f, respectively, hold data that indicates the constraints for each property. Some of these properties are primitives and others (e.g., sufficient grounds and counterindications and side effects) refer to concepts for which values are instances of the concept. These properties offer the advantage of providing the knowledge used by virtual mentors to train, advise and evaluate the actions of real or virtual clinicians and used by real or virtual clinicians to dialog with and counsel real or virtual patients in various simulation embodiments. Other properties and constraints are indicated by ellipsis.

FIG. 7C is a block diagram that illustrates an example medical treatment concept 760 in the hierarchical data structure for storing expert knowledge about a medical procedure, according to an embodiment. The concept ID field 761, parent ID field 765, language field 771 and synonyms field 772, and fields for other languages indicated by ellipsis, are as described above for corresponding fields in other concepts. The concept name field 763 holds data that indicates a medical-treatment concept. Field 777 and other fields represented by ellipsis hold data that indicates a script for the medical treatments, including a script for generating an instance from the concept.

Field 773a holds data that indicates sufficient grounds to administer the treatment; field 773b holds data that indicates counterindications that advise against administering the treatment; field 773c holds data that indicates health risks to the patient, field 773d holds data that indicates a pain or discomfort level experienced by the patient during the treatment; field 773e holds data that indicates any side effects of the treatment not described by properties of fields 773b, 773c or 773d; and, field 773f holds data that indicates a hype level for the treatment, such as relative or absolute frequency of appearance in advertisements or trade association articles, or some combination. Fields 775a, 775b, 775c, 775d, 775e and 775f, respectively, hold data that indicates the constraints for each property. Some of these properties are primitives and others (e.g., sufficient grounds and counterindications and side effects) refer to concepts for which values are instances of the concept. These properties offer the advantage of providing the knowledge used by virtual mentors to train, advise and evaluate the actions of real or virtual clinicians and used by real or virtual clinicians to dialog with and counsel real or virtual patients in various simulation embodiments. Other properties and constraints are indicated by ellipsis.

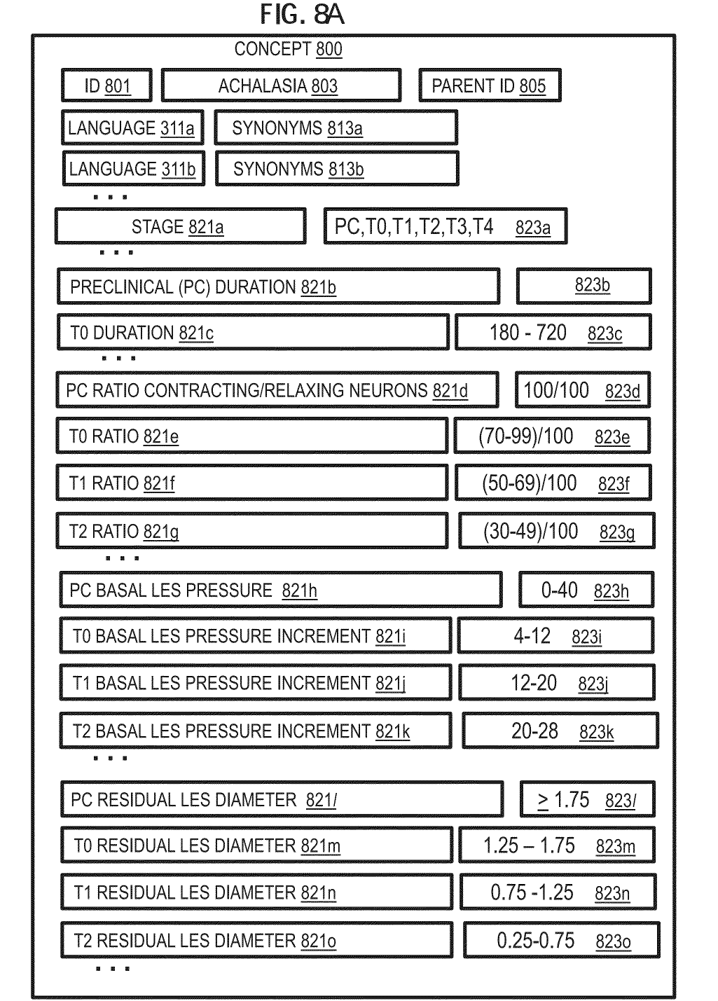

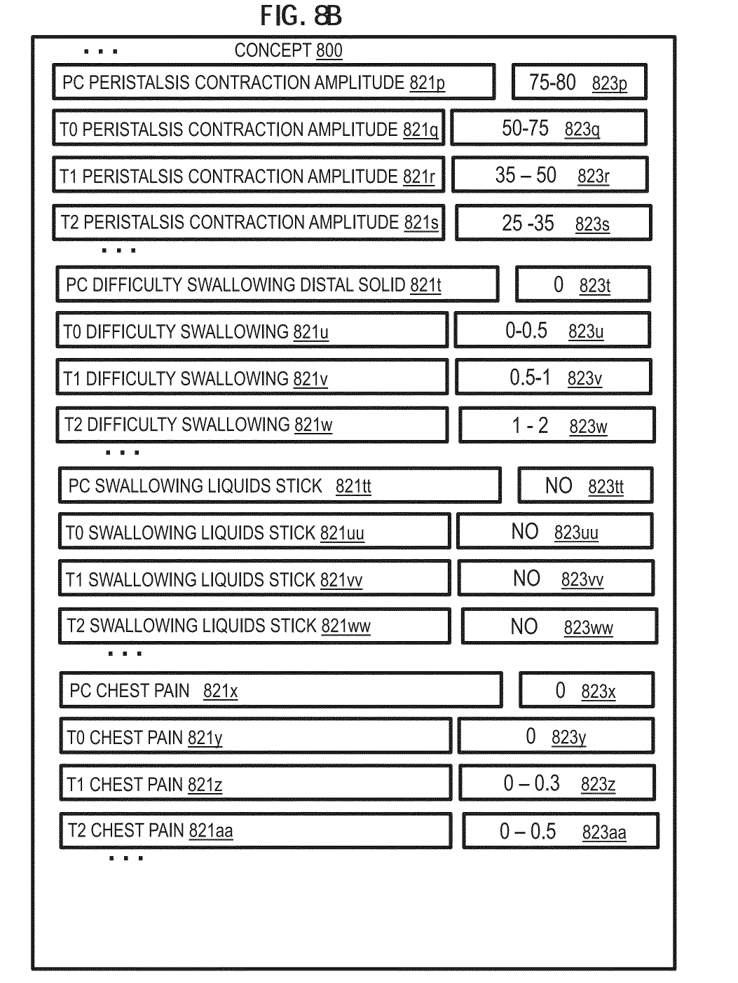

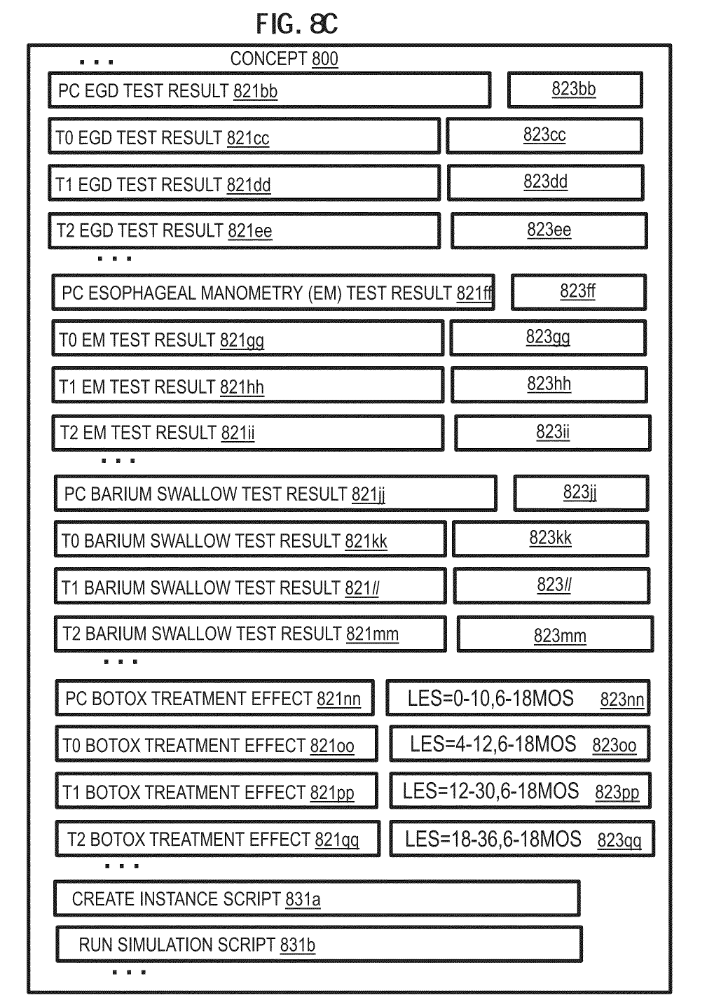

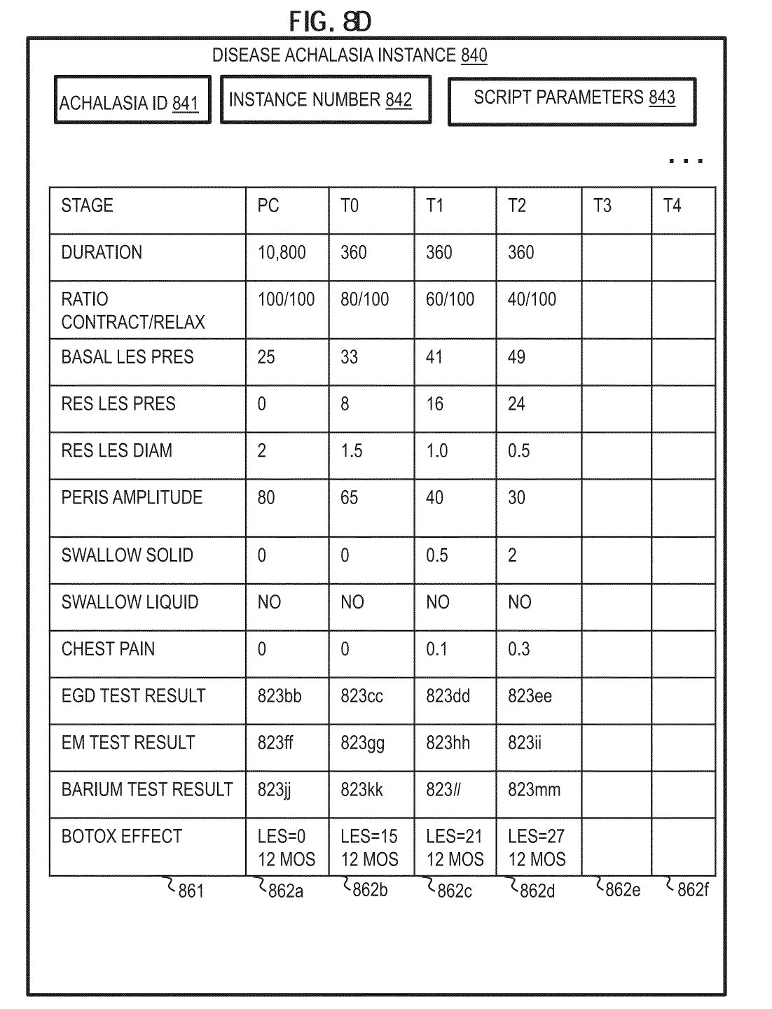

The disease concept 700 of FIG. 7A refers to any disease in a class of diseases, e.g., diseases of mammals, or diseases of humans, or diseases of the heart. An individual disease concept is a child of the concept 700 for a class of diseases. For purposes of illustration, an example disease concept, the concept for the disease achalasia of the gastrointestinal system is described next. FIG. 8A, FIG. 8B and FIG. 8C are block diagrams that illustrate an example achalasia concept 800 in the hierarchical data structure for storing expert knowledge about the disease achalasia, according to an embodiment. Referring to FIG. 8A, the concept ID field 801, parent ID field 805, language and synonyms fields 311a, 311b, 813a, 813b, and fields for other languages indicated by ellipsis, are as described above for corresponding fields in other concepts. In the illustrated embodiment, the parent ID field 805 holds data that refers to the concept ID indicated in field 701 of the parent disease type concept. The concept name field 803 holds data that indicates the disease achalasia.

The number of stages and number of physiological expressions and number of perceptible symptoms and number of useful tests and number of effective treatments for achalasia are given by the values of those properties that are inherited from the parent concept and are not repeated in FIG. 8A to conserve space. For purposes of illustration, the value fields (not shown) for those properties of the disease achalasia assumed to be 6 stages, 4 or more physiological expressions, 3 or more symptoms, 3 or more useful tests and 3 or more effective treatments. Also not repeated in FIG. 8A to conserve space are the fields indicating sufficient grounds and preferred actions and probability by population cluster and their corresponding value fields.

The stage field 821a holds data that indicates the names of the 6 stages and the name values are indicated by the data held in the constraints field 823a. For purpose of illustration, it is assumed that the six stages are represented by the names PC (for pre-clinical to indicate before any signs of the disease emerge), T0 for the earliest stage of the disease with any symptoms or physiological effects or some combination and T1, T2, T3 and T4, respectively, for the successively later stages. In some embodiments, the preclinical stage is named T0 and the following stages are named T1 through T5. For each stage, one or more primitive or concept based properties are defined, such as the duration of the stage and the physiological expressions, perceptible symptoms, useful tests and effective treatments. Field 821b holds data that indicates the primitive property called duration of the preclinical stage and field 823b holds data that indicates the constraints (e.g., a range of days from the number of days representing the earliest age for onset of the disease, e.g., 100 days, to a large number of days that indicates the entire expected life of the patient who never contracts the disease and is always preclinical, e.g., 40,000 days). Field 821c holds data that indicates the property called duration of the T0 stage and field 823c holds data that indicates the constraints (e.g., a range from 180 days to 720 days). In some embodiments, a range for this or one or more other properties, in any combination, indicates a range for a large majority of patients, e.g., plus or minus two standard deviations; and, an instance of the disease for an individual real or virtual patient has a small chance of having a duration outside this range. The durations of other stages are indicated by ellipsis.

Field 821d holds data that indicates the physiological expression property called ratio of contracting neurons to relaxing neurons during swallowing at the pre-clinical stage (PC) and field 823d holds data that indicates the constraints (e.g., a default value of 100 contracting neurons per 100 relaxing neurons). Fields 821e, 821f and 821g each holds data that indicates the ratio of contracting neurons to relaxing neurons during swallowing at the next three stages (T0, T1, T2, respectively). Fields 823e, 823f and 823g each holds data that indicates the constraints (e.g., a range of 70 to 99 contracting neurons, a range of 50 to 69 contracting neurons and a range of 30 to 49 contracting neurons, respectively for these three stages, per 100 relaxing neurons). The ratios at other stages are indicated by ellipsis.

Field 821h holds data that indicates the physiological expression property called basal lower esophageal sphincter (LES) pressure at the pre-clinical stage (PC) and field 823h holds data that indicates the constraints (e.g., a range of 0 to 40 torr). The term “basal” refers to the pressure during tightening of the sphincter. Fields 821i, 821j and 821k each holds data that indicates an increment in the basal LES pressure at the next three stages (T0, T1, T2, respectively). Fields 823i, 823j and 823k each holds data that indicates the constraints (e.g., an increment in a range of 4 to 12 torr, an increment over stage T0 in a range of 12 to 20 torr and an increment over stage T0 in a range of 20 to 28 torr, respectively for these three stages). The basal LES pressures at other stages are indicated by ellipsis.

Field 8211 holds data that indicates the physiological expression property called residual lower esophageal sphincter (LES) diameter at the pre-clinical stage (PC) and field 8231 holds data that indicates the constraints (e.g., a range greater than or equal to 1.75 centimeters, cm). The term “residual” refers to the pressure during relaxation of the sphincter. Fields 821m, 821n and 821k each holds data that indicates the residual LES diameter at the next three stages (T0, T1, T2, respectively). Fields 823m, 823n and 823o each holds data that indicates the constraints (e.g., a range of 1.25 to 1.75 cm, a range of 0.75 to 1.25 cm and a range of 0.25 to 0.75 cm, respectively for these three stages, all ranges exclusive of the upper limit). The residual LES diameters at other stages are indicated by ellipsis.

Referring to FIG. 8B, field 821p holds data that indicates the physiological expression property called peristalsis contraction amplitude at the pre-clinical stage (PC) and field 823p holds data that indicates the constraints (e.g., a range from 75 to 80 in arbitrary units). Fields 821q, 821r and 821s each holds data that indicates the contraction amplitude at the next three stages (T0, T1, T2, respectively). Fields 823q, 823r and 823s each holds data that indicates the constraints (e.g., a range of 50 to 75, a range of 35 to 50 and a range of 25 to 35, respectively for these three stages). The peristalsis contraction amplitudes at other stages, and other physiological properties, such as residual LES pressure, are indicated by ellipsis.

Field 821t holds data that indicates the perceptible symptom property called difficulty swallowing solid in distal portion of esophagus at the pre-clinical stage (PC) and field 823t holds data that indicates the constraints (e.g., default value of 0 on scale from 0 to 2). Fields 821u, 821v and 821w each holds data that indicates the difficulty swallowing solid at the next three stages (T0, T1, T2, respectively). Fields 823u, 823v and 823w each holds data that indicates the constraints (e.g., a range of 0 to 0.5, a range of 0.5 to 1 and a range of 1 to 2, respectively for these three stages). The difficulty swallowing solid at other stages are indicated by ellipsis.

Field 821tt holds data that indicates the perceptible symptom property called swallowing liquids stick at the pre-clinical stage (PC) and field 823tt holds data that indicates the constraints (e.g., default value “NO”). Such sticking is usually perceived in stages later than T2. Fields 821uu, 821vv and 821ww each holds data that indicates swallowing liquids stick at the next three stages (T0, T1, T2, respectively). Fields 823uu, 823vv and 823ww each holds data that indicates the constraints (e.g., a value of “NO” for these three stages). The properties of swallowing liquids stick at other stages are indicated by ellipsis.

Field 821x holds data that indicates the perceptible symptom property called chest pain at the pre-clinical stage (PC) and field 823x holds data that indicates the constraints (e.g., default value of 0 on scale from 0 to 1). Fields 821y, 821z and 821aa each holds data that indicates the property chest pain at the next three stages (T0, T1, T2, respectively). Fields 823y, 823z and 823aa each holds data that indicates the constraints (e.g., a default value of 0, a range of 0 to 0.3 and a range of 0 to 0.5, respectively for these three stages). The chest pain properties at other stages, and other perceptible symptom properties, if any, are indicated by ellipsis.

Referring to FIG. 8C, field 821bb holds data that indicates the expected test result property called esophagogastroduodenoscopy (EGD) test result at the pre-clinical stage (PC) and field 823bb holds data that indicates the constraints (e.g., a function of values of one or more of the physiological expressions, such as equal to the residual LES diameter). Fields 821cc, 821dd and 821ee each holds data that indicates the EGD test result at the next three stages (T0, T1, T2, respectively). Fields 823cc, 823dd and 823ee each holds data that indicates the constraints. The expected EGD test results at other stages are indicated by ellipsis.

Field 821ff holds data that indicates the expected test result property called esophageal manometry (EM) test result at the pre-clinical stage (PC) and field 823ff holds data that indicates the constraints (e.g., a function of values of one or more of the physiological expressions). Fields 821gg, 821hh and 821ii each holds data that indicates the EM test result at the next three stages (T0, T1, T2, respectively). Fields 823gg, 823hh and 823ii each holds data that indicates the constraints. The expected EM test results at other stages are indicated by ellipsis.

Field 821jj holds data that indicates the expected test result property called barium swallow test result at the pre-clinical stage (PC) and field 823jj holds data that indicates the constraints (e.g., a function of values of one or more of the physiological expressions). Fields 821kk, 821ll and 821mm each holds data that indicates the barium swallow test result at the next three stages (T0, T1, T2, respectively). Fields 823kk, 823ll and 823mm each holds data that indicates the constraints. The expected barium swallow test results at other stages, and other expected test result properties, if any, are indicated by ellipsis.

Field 821nn holds data that indicates the expected treatment effect property called botox treatment effect at the pre-clinical stage (PC) and field 823nn holds data that indicates the constraints (e.g., basal LES increments of 0 to 10 torr for six to 18 months after administration). The botox treatment refers to the administration of the drug BOTOX™ from ALLERGAN, INC.™ of Irvine, Calif., at the distal portion of the esophagus. Fields 821oo, 821pp and 821qq each holds data that indicates botox treatment effect at the next three stages (T0, T1, T2, respectively). Fields 823oo, 823pp and 823qq each holds data that indicates the constraints (e.g., an increment range of 4 to 12 torr, an increment range of 12 to 30 torr and an increment range of 18 to 36 torr, respectively, each for six to 18 months after administration at these three stages). The expected botox treatment effect at other stages, and other expected treatment effect properties, such as effects of Heller myotomy and pneumatic dilation, are indicated by ellipsis.

Field 831a holds data that indicates a script to create an instance of the achalasia disease, e.g., for affecting a particular virtual patient, by selecting actual values of the various properties for the particular patient, either automatically based on population statistics, or in response to inputs supplied by a human author or mentor, manually or in recorded files, or some combination. Field 831b holds data that indicates a script to run a simulation of the progression of an instance of the disease for an instance of a virtual or real patient with or without treatments at one or more times during the simulation, with inputs provided automatically, e.g., from stored files of preferred or usual treatments, or based on input from a human clinician or mentor, or some combination. Additional scripts, if any, are indicated by ellipsis.

FIG. 8D is a block diagram that illustrates an example instance 840 of the disease achalasia in the hierarchical data structure, according to an embodiment. The instance includes field 841 that holds data that indicates the concept ID (e.g., the value from the field 801 described with reference to FIG. 8A for the concept achalasia). The instance number field 842 holds data that uniquely identifies this instance of the disease from all other instances of the disease associated with other real or virtual patients. The script parameters field 843 holds data that indicates the input values for one or more parameters, if any, used by the script 831a to generate this instance, e.g., values for one or more physiological expressions or data identifying a population from which values for those properties are derived, e.g., by using a statistic of the population, such as an average value or a random selection from a probability distribution that matches the populations distribution. Other fields, if any, are represented by ellipsis.

The remaining example values for the instance are represented by a table in which each row represents a different property indicated by the name in column 861 and the remaining columns 862a, 862b, 862c, 862d, 862e and 862f hold data that indicate a value for that property at the six stages of the disease from PC through T4, respectively. Note that, unlike the constraints in the concept for this disease, no ranges are indicated in the disease instance; instead, each stage of each property has a specific value. These values satisfy the constraints for each property indicated in the concept 800. Some values are the same as the default values indicated in the concept only by field identifiers, and such values are indicated in FIG. 8D by the field identifier used in FIG. 8C. For simplicity, no example values are given for stages T3 and T4.

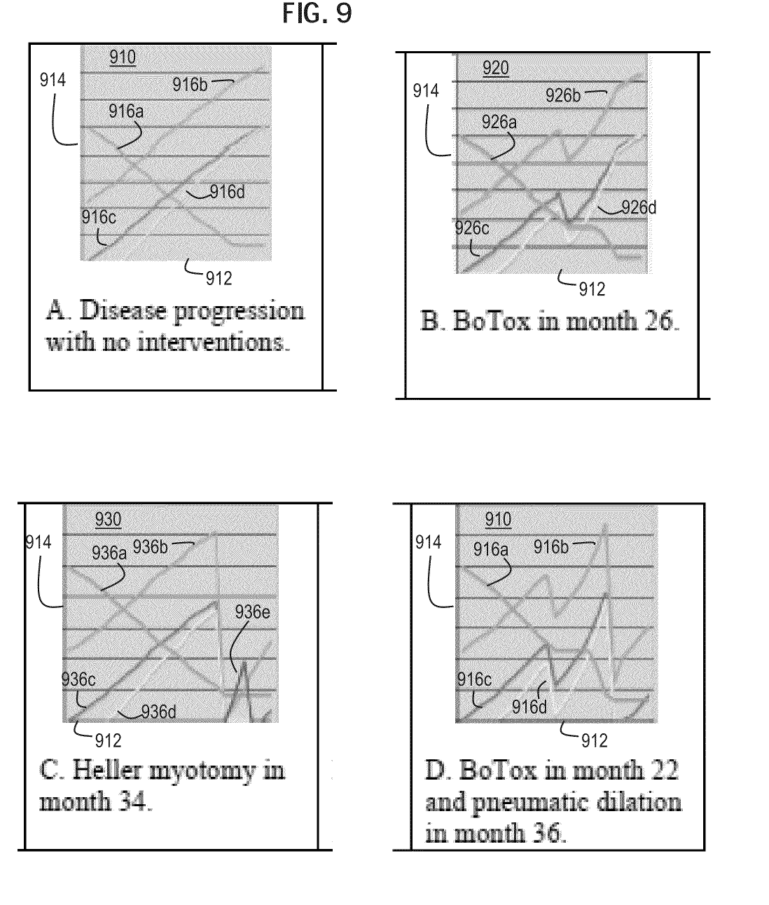

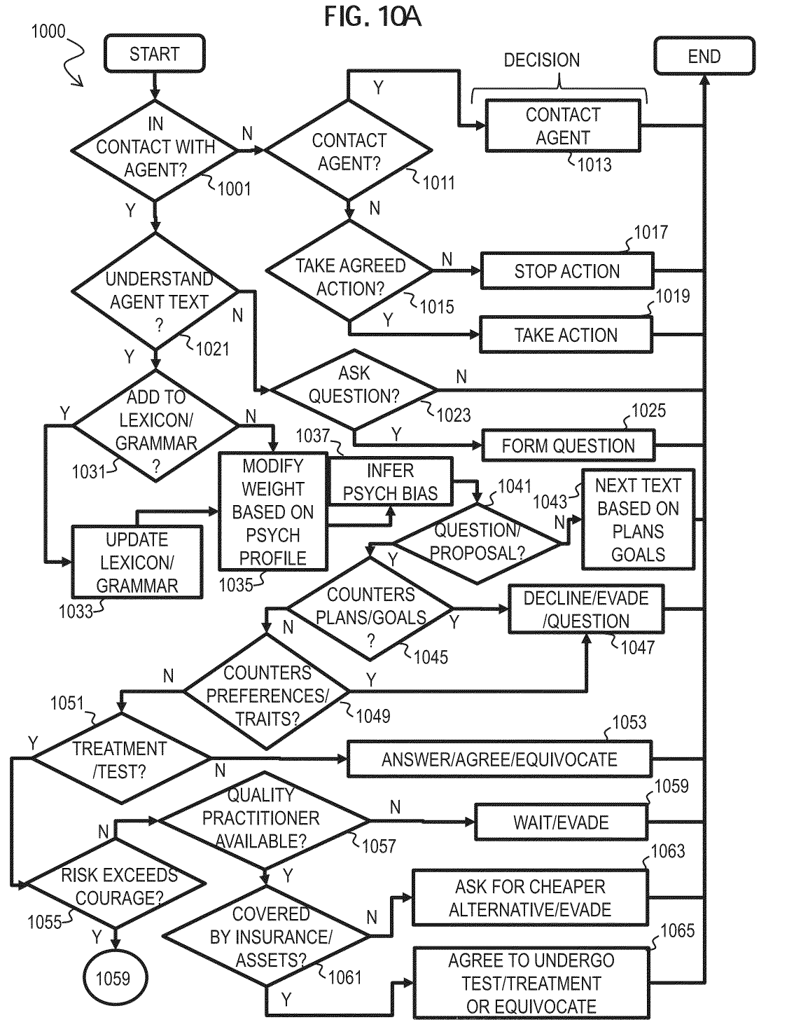

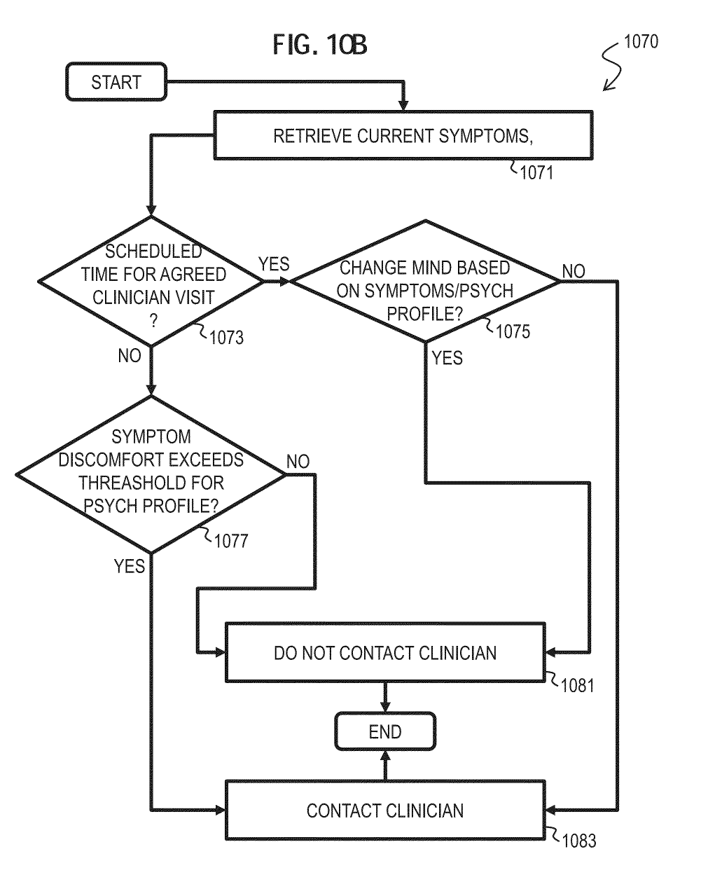

FIG. 9A, FIG. 9B, FIG. 9C and FIG. 9D are graphs 910, 920, 930 and 940, respectively, which illustrate example simulations of the progression of the instance of achalasia of FIG. 8D in response to various treatments and treatment times, according to one or more embodiments. This instance is associated with a particular virtual patient who has the disease achalasia, which is a disease that raises the basal (“tight”) and residual (“relaxed”) pressure of the lower esophageal sphincter (LES), making it increasingly difficult for food to pass to the stomach. Horizontal axis is time, spanning about 40 months and the vertical axis 914 is relative value in arbitrary units, showing the progression of several physiological expressions or perceptible symptoms associated with the disease. The graphs represent conditions with no treatment (graph 910), botox treatment in month 26 (graph 920), Heller myotomy in month 34 (graph 930) and a combination of botox in month 22 with pneumatic dilation in month 36 (graph 940).

The amplitude of peristalsis contractions is given by traces 916a, 926a, 936a and 946a in the four graphs, respectively; and decreases over time as the disease progresses until it plateaus at a low value in the graph 910 for untreated disease. The basal lower esophageal sphincter pressure is given by traces 916b, 926b, 936b and 946b in the four graphs, respectively; and increases over time in the graph 910 for untreated disease. The residual lower esophageal pressure is given by traces 916c, 926c, 936c and 946c in the four graphs, respectively; and also increases over time in the graph 910 for untreated disease. The difficulty swallowing solids is given by traces 916d, 926d, 936d and 946d in the four graphs, respectively; and, also tends to increase over time in the graph 910 for untreated disease. The heartburn symptom is given by trace 936e which appears only as a result of the myotomy in graph 930. The temporary effect of botox is evident in graphs 920 and 940, along with more dramatic effects of pneumatic dilation in graph 940. A dramatic effect on traces 936b, 936c and 936d in graph 930 comes at the cost of increased heartburn in trace 936e.

It is noted that these four scenarios are but a handful of the thousands of scenarios one could create using this patient instance, since any of the treatments could be administered in any combination at any time. In addition, the system does not rule out the possibility of the user ordering incorrect treatments that could worsen the patient's condition, creating a more complicated case that the user must manage. Moreover, hundreds of other patient instances could be authored from the basic ontological model of a disease, making the scope of cases truly wide and differentiated.

The advantages of physiological simulation for a VP are thus made evident. The system 100 utilizes a simulated virtual patient to provide the patient management challenges for training new clinicians—open-ended simulations over time that permit trial-and-error learning in an environment that includes many salient features of real clinical practice. But the utility of physiological simulation in system 100 does not end there. A virtual mentor (providing pedagogical guidance to a trainee in some embodiments, and advising a more experienced clinician in other embodiments) uses physiological simulation as means of knowledge gathering to contribute to developing prognoses that can affect decision-making and advice-giving.

For example, the system 100 already has ontological models that provide for the real-world scope of disease progressions and patient features. At an arbitrary time during operation of the system 100, some features of a live patient and the patient's disease are known while others are not. These features are used to construct an instance of the live patient's disease, or a virtual patient representing the live patient, or some combination. In some embodiments, the features that are known are inserted into the disease instance, thus “personalizing” the instance used to model the disease—i.e., making the instance progressively less a generic, population-scale model and more the model of a particular patient's condition. In some embodiments, one or more simulations are run using the known patient-related features and some less precise population-scale constraints over the remaining feature values. Of course, the more features that are known, the more constrained the number of disease paths and outcomes; but even with few features known, some partially personalized reckoning about what might happen to a patient in a given time frame is possible.

To illustrate how simulations are used in some embodiments for advising a clinician about treatment for a real or virtual patient, it is assumed that the best advice a virtual mentor gives at a certain point in time is that the patient have Procedure X. However, it is further assumed that Procedure X has a recovery time of 2 weeks and the patient cannot afford that amount of time off work until summer vacation in 3 months. The patient wants to know how bad things will get if the procedure is put off that long. The virtual mentor runs simulations and presents the clinician with the likely states of disease, including symptom profiles, in 3 months' time. In various embodiments, the system 100 present this simulation output in a presentation format to the clinician such that the clinician interprets the output and formulates a recommendation for the patient, or the system 100 directly interprets the material, formulating its own advice about whether or not the patient can wait, and presenting that advice as simulation output, along with justification for that advice in some embodiments. Some embodiments offer forecasts in tabular form. Other embodiments generate natural language outputs like, “Waiting will not be a good idea because it is expected that the patient will have lost between 15 and 20 lbs. by then.”

### 3. Example Virtual Agent Reasoning Engine

FIG. 10A is a flow chart that illustrates an example method 1000 for executing a reasoning module that depends on psychological profile data to determine simulation output that represents the agent's response, according to an embodiment. Method 1000 is a particular embodiment of step 525 of method 500 depicted in FIG. 5, and is based at least in part on a psychological profile of one or more independently reasoning agents. The next processing cycle starts at step 1001.

In step 1001 the agent determines whether it is in contact with another agent. For example, an independently reasoning agent representing a real or virtual clinician determines whether it is interacting with a real or virtual patient; or, an independently reasoning agent representing a real or virtual patient determines whether it is interacting with an agent representing a real or virtual clinician. In some embodiments, an independently reasoning agent representing a real or virtual mentor determines whether it is monitoring actions of a real or virtual clinician. If not, then in step 1011 the agent determines whether to establish contact with another agent. For purposes of illustration it is assumed that the agent performing the steps of method 1000 is an independently reasoning agent that represents a instance of a virtual patient, simply called a virtual patient herein. In this embodiment, the virtual patient determines in step 1011 whether to contact a different independently reasoning agent instance that represents a real or virtual clinician, for example based on a scheduled appointment or severity of one or more symptoms of a disease as described in more detail with reference to FIG. 10B.

FIG. 10B is a flow chart that illustrates an example method 1070 for executing a step 1011 of the method of FIG. 10A that further depends on psychological profile data, according to an embodiment. Method 1070 is therefore a particular embodiment of step 1011. In step 1070 the current symptoms for the virtual patient are retrieved from the memory instance of the virtual patient, or from the interoception module 212, based on the instance of the disease the virtual patient has, e.g., the symptoms for achalasia.

In step 1073 it is determined whether the simulation time is equal to an agreed time for a visit with the clinician (e.g., a physician). If so, control passes to step 1075 to determine whether the virtual patient changes its mind about going to the scheduled visit based on the severity of the symptoms and the psychological (psych) profile of the virtual patient. For example, if the current symptoms for the instance of the disease produce levels of disability (e.g., for properties difficulty swallowing solids and liquids) and pain (e.g., chest pain) that are well tolerated by the instance of the virtual patient based on the values in fields 634q and 634r for the properties tolerance to pain and tolerance to disability, respectively, and if the psychological profile for the instance of the virtual patient includes a value against going to see a physician, e.g., among the values for the biases property 633n, then the virtual patient determines in step 1075 to change its mind about keeping the scheduled appointment.

If it is determined in step 1075 that the virtual patient changes its mind about keeping the scheduled visit, then control passes to step 1081, in which the clinician is not contacted by the virtual agent. Otherwise, control passes to step 1082 and the virtual patient contacts the clinician to begin a dialog with the clinician, according to the scheduled visit.

If it is determined in step 1073 that it is not time for a scheduled visit, control passes to step 1077. In step 1077, it is determined whether the symptom stress or discomfort (as used herein, discomfort or stress includes perceived pain and risk and disability) exceed a threshold for the patient to act based on the psychological profile of the patient. For example, if the current symptoms for the instance of the disease produce levels of disability (e.g., for properties difficulty swallowing solids and liquids) and pain (e.g., chest pain) that are not well tolerated by the instance of the virtual patient based on the values in fields 634q and 634r for the properties tolerance to pain and tolerance to disability, respectively, then the virtual patient determines based on its goals to feel well to execute the associated plan to see a clinician when symptoms exceed tolerance. If it is determined in step 1077 that the discomfort exceeds the tolerance of the virtual patient, then control passes to step 1082, in which the clinician is contacted by the virtual agent to begin a dialog with the clinician. Otherwise, control passes to step 1081 and the virtual patient does not contact the clinician.

Returning to FIG. 10A, if it is determined in step 1011 to establish contact with another agent, then in step 1013 the decision is made to contact the other agent and the current processing cycle ends for step 525 depicted in FIG. 5A. The next processing cycle starts again at step 1001. If it is determined in step 1011 not to establish contact with another agent, then control passes to step 1015. In step 1015 it is determined whether to take an agreed action, such as to diet or stop smoking or start an exercise regimen. Again, depending on the perceived discomfort and the psychological profile of the virtual patient, similar to method 1070, the agent may decide in step 1015 not to take the agreed action. In some embodiments, the agent considers the action in comparison to the agent's value for lifestyle type property 633j. Then control passes to step 1017 to make the decision to stop or fail to start the agreed action and the current processing cycle ends. If in step 1015, the agent decides to take the agreed action, then control passes to step 1019 in which the decision is made to take the agreed action, e.g., the virtual patient decides to not smoke some cigarettes or to lose some weight by dieting or to increase cardio function by exercising, etc. Then the processing cycle ends. The next processing cycle starts again at step 1001.

If it is determined in step 1011 that the agent is in contact with another agent, then in step 1021 it is determined whether text received from the other agent is understood. For example, text from the other agent representing a clinician is processed using the deep language processing module 220 and presented to the virtual patient in the lexicon of the virtual patient, as much as possible. If a new concept is presented that does not exist in the lexicon of the virtual patient, and cannot be inferred from the context of the dialog (e.g., that an EGD must be a test procedure of some kind) then the virtual patient does not understand the text. If the text is not understood, then control passes to step 1023. In step 1023, it is determined whether to ask a question to clarify the meaning of the text. Depending on the plans and goals of the agent and the psychological profile of the agent (e.g., values for interest in learning property 633b or phobia to admitting ignorance), the agent will ignore the text not understood or decide to ask a question to clarify. If it is determined in step 1023, to ignore the text not understood, then the decision is made not to ask a question and the processing cycle ends. If it is determined in step 1023 to ask a question, then in step 1025 the decision is made to form a question (e.g., using deep language processing module 220) to send to the other agent, ending this processing cycle.

If it is determined in step 1021 that the text is understood, then in step 1031 it is determined whether to add any new concepts to the lexicon or grammar of the agent. For example, the virtual patient may decide to add the new concept to the short term memory for the current dialog but not make the knowledge permanent by adding to the lexicon. In some embodiments, this decision is also based on the psychological profile of the agent. If it is determined, in step 1031 to add any new concepts to the lexicon, then that decision is made in step 1033. In either case control then flows to step 1035.

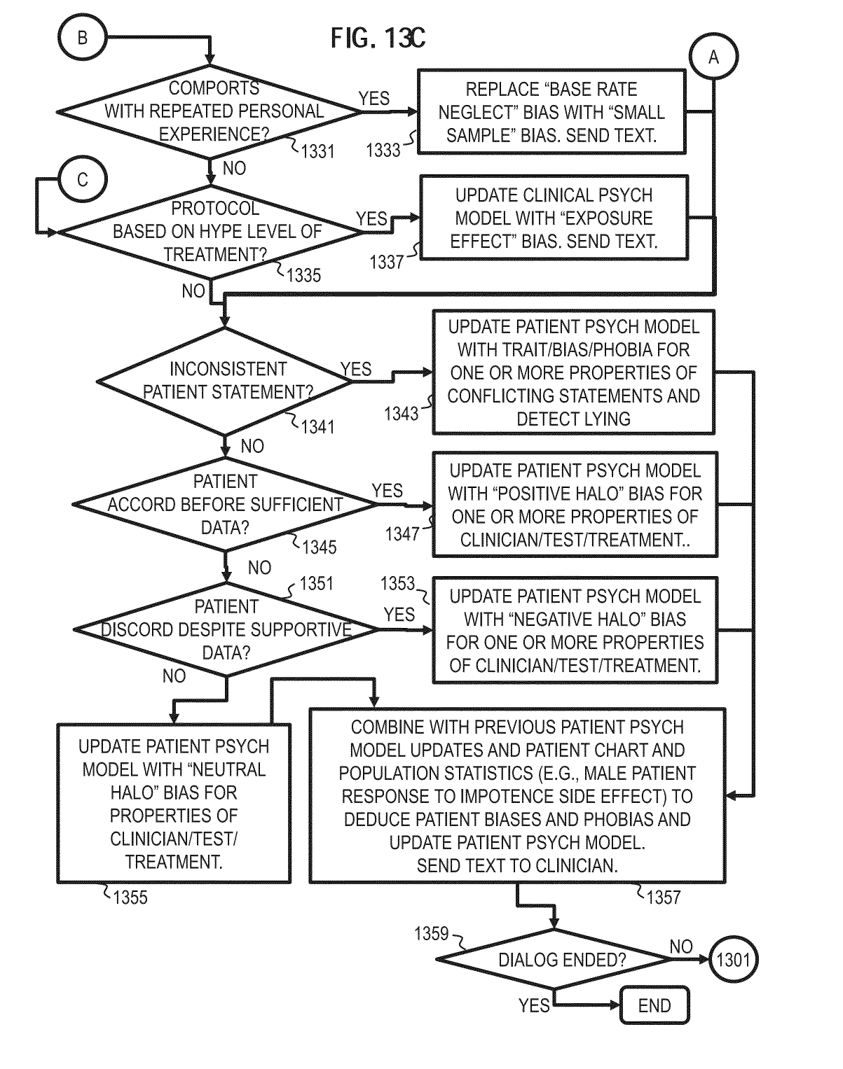

In step 1035, the weight given to the meaning of the text received from the other agent is modified based on the psychological profile of the agent and the agent's model of the psychological profile of the other agent. For example, if a value for the biases property of a virtual patient psychological profile includes a positive halo effect and the virtual patient model of the psychological profile of the clinician includes a high affability value, then the text from that clinician will be given more weight in the decisions to be made by the virtual patient in the later steps described below. In step 1037, the agent infers the biases phobias and other data for the agent's model of the psychological profile of the other agent based on the understood text. For example, the virtual patient updates the virtual patient's model for the psychological profile of the clinician based on the text, such as the knowledge shown or affability in wording or stating things in a positive way. In some embodiments, a virtual mentor infers biases in an agent representing a real or virtual clinician during step 1037, as described in more detail below with reference to FIG. 13A.

In step 1041, it is determined whether the text represents a question or proposal that requires a reply from the agent. If not, control passes to step 1043 in which it is decided to base the next text or action from the agent on the agent's own plans and goals. The processing cycle then ends. For example, in step 1043 the virtual patient decides to ask the clinician a question about one or more symptoms the virtual patient has perceived. If it is determined, in step 1041, that the text represents a question or proposal, then control passes to step 1045.

In step 1045, the agent determines whether the question or proposal runs counter to the agent's own goals or plans. If so, then in step 1047 the agent decides to decline or evade the question or proposal or to ask a question. Then the processing cycle ends. If not, then control passes to step 1049. In step 1049 the agent determines whether the question or proposal counters the agent's own preferences and personality traits, such a tolerance to pain or tolerance to disability or lifestyle type or beliefs (e.g., that medication is superior to surgery), or biases, or phobias (such as fear of confined spaces involved in MRI procedures). If so, control also passes to step 1047 to decide to decline or evade or question the proposal.

If it is determined that the question or proposal does not counter the agent's plans or preferences, then in step 1051 it is determined whether the text proposes a medical procedure (i.e., test or treatment). If not, then, in step 1053, the agent decides to answer the question or agrees to the proposal or further equivocates, e.g., by thinking of some other questions, depending on the biases and phobias in the agent's psychological profile, and the processing cycle ends.

If it is determined in step 1051 that a medical procedure is being proposed, then additional factors are considered by the agent. In step 1055 it is determined whether the risk of the procedure (e.g., from field 755c or 775c) exceeds the agent's tolerance for risk (e.g., from field 634p, also called courage). If so, control passes to step 1059 to decide to wait or evade the procedure. If it is determined, in step 1055, that the risk of the procedure does not exceed the agent's tolerance for risk, then in step 1057 it is determined whether a high quality practitioner of the procedure is available. If not, then control also passes to step 1059 to decide to wait or evade the procedure. If a high quality practitioner of the procedure is available, then control passes to step 1061 to determine whether the financial costs of the procedure are covered by the patient's health insurance or assets or some combination. If not, then in step 1063 the agent decides to evade the procedure or request a cheaper alternative, and the processing cycle ends. If so, then in step 1065 the agent decides to agree to undergo the procedure or still equivocate, depending on the biases and phobias in the agent's psychological profile, and the processing cycle ends.

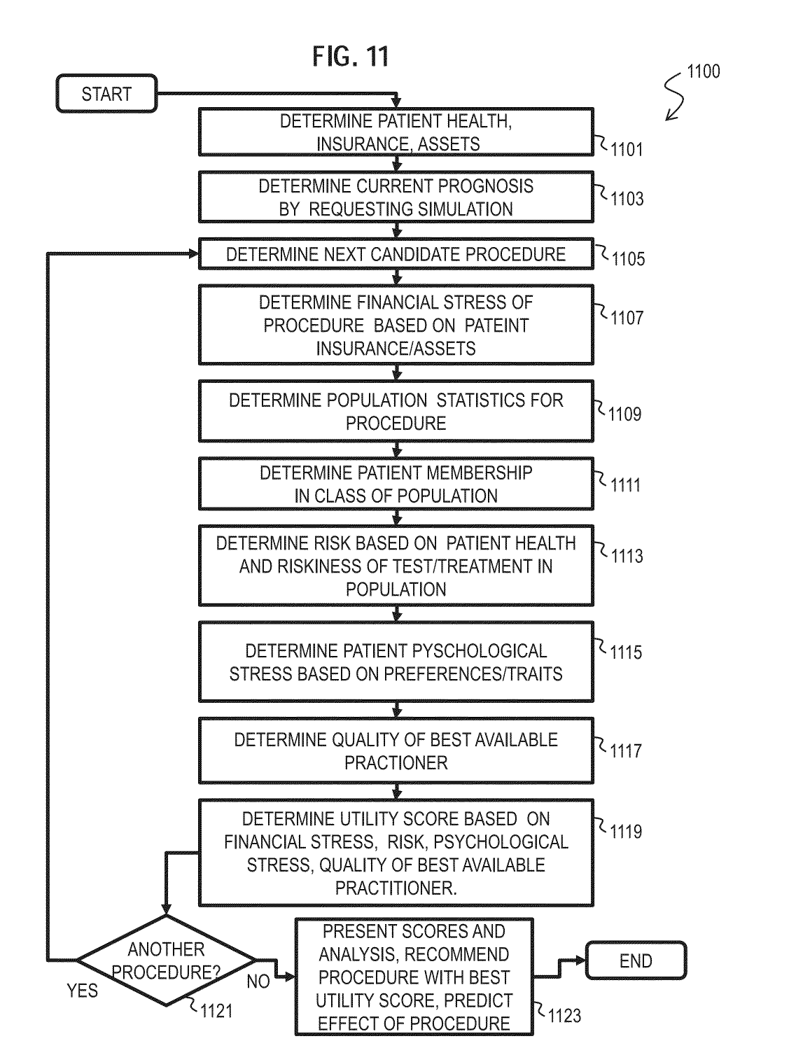

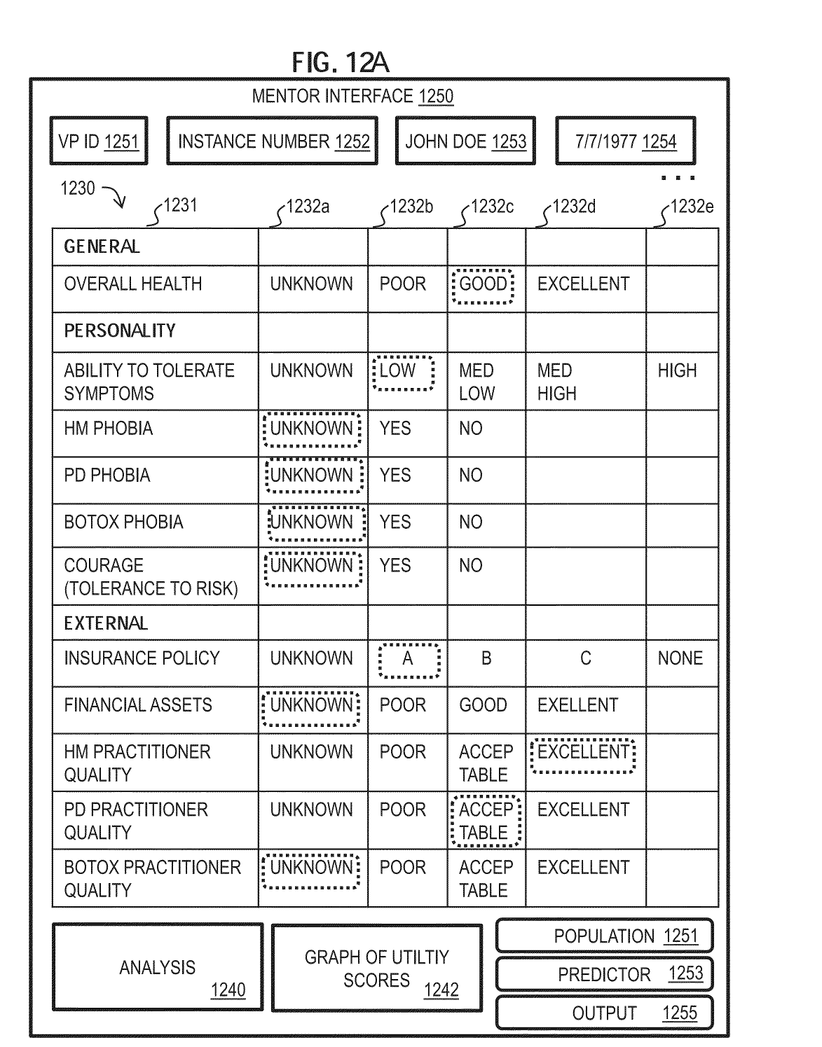

FIG. 11 is a flow chart that illustrates an example method 1100 for executing a reasoning module that depends on psychological profile data of a patient to determine simulation output that recommends a medical procedure, according to another embodiment. For example, the method 1100 is performed in the reasoning engine of a virtual mentor during step 1043 to achieve the virtual mentor's goal of advising a real or virtual clinician on the best procedure for a real or virtual patient having a particular disease, so that the patient is less likely to decide to evade the procedure in step 1059 of the virtual patient's reasoning engine. For the purpose of illustration, the method is described as if the agent is a virtual mentor advising a real clinician represented by a virtual clinician about a real patient represented as a virtual patient that has the disease achalasia.

In step 1101, the virtual mentor determines the patient's overall health, insurance policy and financial assets. In an example embodiment, the values for these properties are stored in fields 682c, 682d and 682e of an instance of a patient chart 670, as depicted in FIG. 6D. If not asked for by the clinician, or otherwise missing, during step 1101, the virtual mentor prompts the clinician to ask for these values in the dialog between the clinician and the patient. In addition, step 1101 includes determining the disease hypothesized or diagnosed for the patient from field 682f or field 682g or field 682h of the patient chart 670.

In step 1103 the current prognosis for the patient without any procedure is determined, e.g., by running simulation script 831b of the achalasia concept with values for an instance of the disease. The values of disease properties in one or more stages are based on actual tests already performed on the patient, where available, and population appropriate values for a population cluster to which the patient belongs for other properties not directly measured in the patient. Any method may be used to determine the population cluster to which the patient belongs. For example, in various embodiments, the population is the full population, or the population of persons of the same gender in the same age group with the same overall health condition (e.g., poor, fair, good, excellent).

In step 1105, a next candidate procedure is determined from a list of two or more useful tests and effective treatments. For purposes of illustration, the candidate procedures are selected from a list of effective procedures including Heller myotomy, pneumatic dilation and botox treatment. The next procedure is one that has not yet been considered.

In step 1107, the financial stress of the procedure is determined based on the insurance policy and financial assets of the patient. The stress is low if the cost of the procedure is low compared to what is covered by the insurance policy or the patient's financial assets or some combination, and increases as the cost of the procedure approaches or exceeds the combination. A utility score is determined in some embodiments, with utility increasing as stress decreases. A financial component utility score is based on the financial stress.

In step 1109, the risk of the procedure in the population is determined based on statistics for the total population and one or more subpopulations (classes) defined by gender or age or overall health or other factors, or some combination. In step 1111, the patient membership in one or more subpopulations is determined, e.g., based on the patient's age or gender or overall health or other factors or some combination. In step 1113 the risk to the patient is determined based on the risk of the procedure in the subpopulation to which the patient belongs, such as a subpopulation characterized by the gender, age and overall health of the patient. A risk utility score component is based on the risk to the subpopulation to which the patient belongs. The higher the risk, the smaller is this component of the utility score.

In step 1115, a psychological stress on the patient is determined based on the patient's preferences and traits, as quantified in the patient's psychological profile. In some embodiments, the expected psychological distress of the procedure is calculated based on the inherent psychological distress of the procedure, any special fears or phobias the person might have, and the person's overall level of courage. For example, if the typical psychological distress associated with the procedure is low at the population level but the patient has a phobia of some aspect of the procedure, then for this patient the distress is high. At the time of making the decision, if the patient chart includes the patient specific values, then those are used; if not, then the population or subpopulation values are used. However, the more population values are used, the less confidence there is in the score and recommendation by the virtual mentor. A psychological utility score component is based on the psychological stress on the patient. The higher the stress, the smaller is this component of the utility score.

In step 1117, the quality of the best available practitioner of the procedure is determined for each of one or more time frames under consideration. A practitioner utility score component is based on the quality of the best available practitioner. The higher the quality, the larger is this component of the utility score.

In step 1119 an overall utility score is determined based on the financial stress, the risk, the physiological stress and the quality of the best available practitioner. For example, the utility score is 80 out of 100 (80/100) for selecting the botox treatment if: the risk is high (e.g., the patient is ill); the patient can afford it; the quality of the best practitioner is acceptable (not excellent or poor); and, the patient has moderate (not low or high) psychological distress associated with the procedure. If practitioner quality is increased to “excellent”, the score goes up to 90/100. If, in addition, psychological distress is reduced to “low”, the score goes up to 100/100.

In step 1121, it is determined whether another procedure is yet to be considered. If so, then control passes back to step 1105 and following steps to determine the next procedure and its utility score. If all procedures have been considered, then control passes to step 1123 to present the scores and analysis, to present the recommended procedure with the best utility score and to predict the effect of the procedure on the prognosis based on a new simulation.

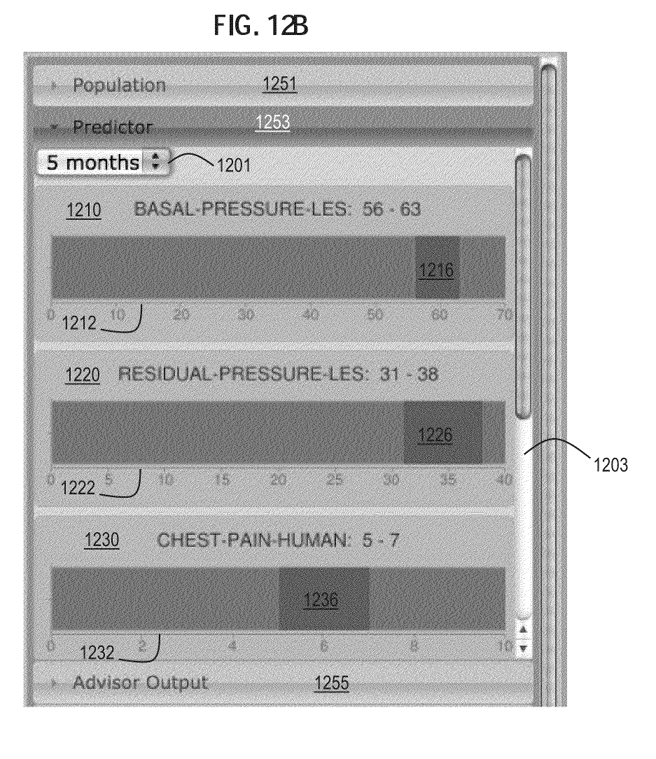

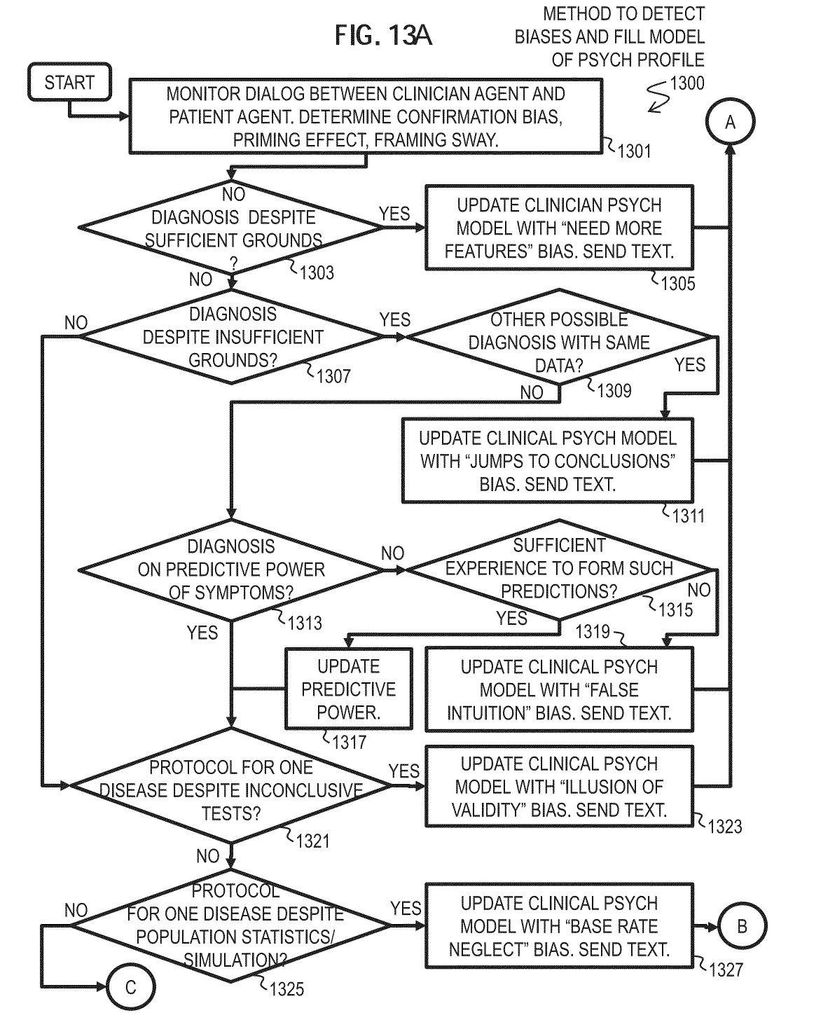

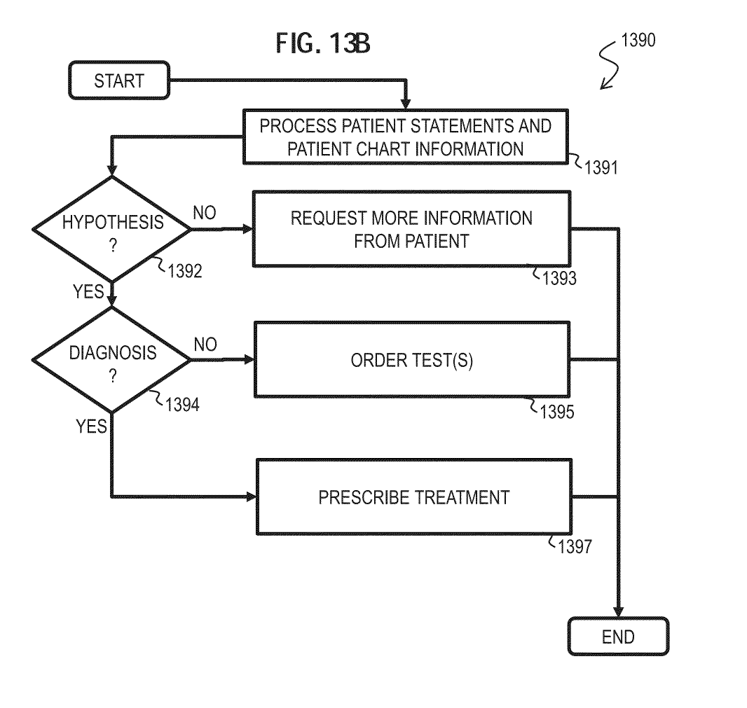

FIG. 12A and FIG. 12B are block diagrams that illustrate an example interface 1250 for preparing and presenting simulation output to a clinician, e.g., on user interface 108, according to another embodiment. These illustrate an example screen on a display device of system 100, according to one embodiment. For example, in some embodiments the display device is display 1414 of a computer system 1400 described below with reference to FIG. 14. The screen includes one or more active areas that allow a user to input data to operate on data. As is well known, an active area is a portion of a display to which a user can point using a pointing device (such as a cursor and cursor movement device, or a touch screen) to cause an action to be initiated by the device that includes the display. Well known forms of active areas are stand alone buttons, radio buttons, check lists, pull down menus, scrolling lists, and text boxes, among others. Although areas, active areas, windows and tool bars are depicted in FIGS. 12A through 12B as integral blocks in a particular arrangement on particular screens for purposes of illustration, in other embodiments, one or more screens, windows or active areas, or portions thereof, are arranged in a different order, are of different types, or one or more are omitted, or additional areas are included or the user interfaces are changed in some combination of ways.

The interface 1250 includes VP ID field 1251 that holds data that uniquely identifies the virtual patient concept, instance number field 1252 that uniquely identifies the instance of the virtual patient, field 1253 that holds data that indicates the name of the virtual patient (e.g., real patient John Doe) and field 1254 that holds data that indicates a birthdate of the patient (e.g., Jul. 7, 1977). The interface 1250 also includes a table 1230 in which column 1231 indicates a property of the virtual patient and the remaining columns 1232a, 1232b, 1232c, 1232d and 1232e indicates selectable values for the corresponding property. The value selected for each property is indicated by a dotted shape and is derived from the patient chart, if available for that property, and from population statistics if unknown. The selected values of the properties are used to determine a best procedure to recommend for this particular patient.

Thus, in the illustrated embodiment, the recommendation depends on the general property of overall health for which the value good is selected, based on the patient chart 670 for this patient. The recommendation also depends on the psychological profile properties (labeled “personality” in table 1230) ability to tolerate symptoms for which the value low is selected based on the value for the property tolerance_to_symptoms in patient chart 670. Values unknown are ascribed to phobias to Heller myotomy (HM), pneumatic dilation (PD) and botox treatment and tolerance_to_risk (courage), since values for these are not expressed in the patient chart 670 in an illustrated embodiment. Furthermore, the recommendation depends on properties external to the patient, including insurance policy, financial assets, HM practitioner quality, PD practitioner quality and botox treatment practitioner quality, for which values policy A, unknown, excellent, acceptable and unknown are selected, respectively, based on values present or absent in the patient chart 670.

The interface 1250 also includes panels and tabs for other screens that can be displayed, including an analysis panel 1240, a graph of utility scores panel 1242, a population screen tab 1251, a predictor screen tab 1253 and an output screen tab 1255. The analysis

panel shows the advisor's advice, which includes its confidence in the given decision and particularly salient property values. In the illustrated embodiment, it reads “Given the current data, we strongly recommend Heller Myotomy. The fact that the patient's overall health is good and that the patient has insurance policy A were especially relevant to this decision.” The feature values that, if changed, would most dramatically affect the decision are presented in contrast (e.g., bold or highlighting) in the analysis panel. The graph of utility scores panel presents a bar graph in which each bar has length proportional to the utility score for one of the candidate procedures. In some embodiments, this graph is only presented when the output tab 1255 is selected.

One of the functionalities of the illustrated virtual mentor is to allow a user to launch a simulation of a patient that has the known features of the actual patient in order to see possible prognoses for the patient. This kind of virtual patient, called a “hypothesized virtual patient (HVP)”, is different from the virtual patients for training in that the HVP has actual values for some parameters (the ones the clinician has determined and recorded in the chart) but ranges of values for other parameters that are as yet unknown. The features that are known can be inserted into the disease model, thus “personalizing” it—i.e., making it progressively less a generic, population-scale model and more the model of a particular patient's condition. One or more simulations can then be run, with the outcomes being more or less predictive based on the number of known vs. unknown property values.

The Predictor tab 1253 is used to open a new screen (or expand the panel) to show prognoses. It is collapsed in FIG. 12A but expanded in FIG. 12B. Here, the clinician has asked to see the likely ranges of values for crucial features—both physiological and symptom related—of the disease in five months' time (more features are hidden due to space constraints in the interface). So, the live clinician can use physiological simulation as means of knowledge gathering to contribute to developing prognoses that can affect decision-making and advice-giving by a virtual mentor in the system 100. The expanded predictor screen (or panel) includes a time for the prognosis in field 1201, indicating 5 months for the illustrated example. For each of several physiological expressions and perceptible symptoms (e.g., basal LES pressure in panel 1210, residual LES pressure in panel 1220 and chest-pain in panel 1230) a range of allowed values form horizontal axis 1212, 1222 and 1232, respectively. A portion of this range is highlighted to cover the predicted values from the simulation, including: the range of 56 to 63 torr in highlighted portion 1216 in panel 1210 for basal LES pressure; the range of 31 to 38 torr in highlighted portion 1226 in panel 1220 for residual LES pressure; and, the range of 5 to 7 in highlighted portion 1236 in panel 1230 for chest pain on a scale from 0 to 10.

The population tab 1251 tab is used to open a new screen (or expand the panel) to show the range of property values in one or more subpopulations of the general population to which the patient belongs.

The reasoning methodology described here pursues a finer-grain size of description and broader-coverage approach to knowledge-based, language-oriented language processing than most others. This method models the physiological body as well as the mind and is, therefore, able to introduce a new kind of perception—interoception; and it attempts to support a variety of perception, reasoning and action operations on the basis of a uniform set of knowledge resources. Prototype embodiments of system 100 advance the notion of virtual patient and virtual mentor to a new level of verisimilitude. Practically all other virtual patients for cognitive training are prefabricated branching narrative scenarios, organized as decision trees, which reflect a specific medical case. In these other approaches, user options are restricted and responses are highly pre-scripted, being delivered through multiple-choice questions. Most importantly, in such other approaches, patient outcomes are fully predetermined by the prefabricated scenario, unlike system 100. The agent architecture described for system 100 allows a variety of configurations of processing and knowledge components to support applications involving complex multi-agent task-driven systems capable of decision making and dialog.

### 4. Example Determination of Psychological Profile

It is advantageous if one or more of the independently reasoning agents, affected by their own psychological profiles, are able to detect and store information about the psychological profiles of other agents. Using the model of the other agent's psychological profile is mentioned above with reference to step 1035 in FIG. 10A. Determining the psychological profile of another agent is mentioned with reference to step 1037 of that same flow diagram. In this section a method is described for an independently reasoning agent, such as a virtual mentor, to infer the psychological profile of another agent, such as a real or virtual patient or a real or virtual clinician. Some of these inferences are made based on inconsistencies.

The term inconsistency tends to imply a negative evaluation of a state of affairs; but, inconsistency can actually serve as a diagnostic tool. For example, in the domain of clinical medicine, inconsistencies between test results and the doctor's hypothesis about what is wrong can suggest that the hypothesis was incorrect or that the test results were flawed, and inconsistencies between a doctor's observation and a patient's report can suggest an intentional or unintentional misrepresentation by the patient. Similarly, in the domain of teaching clinical medicine, inconsistencies between an expert's preferred approach to solving a problem and a novice's approach can suggest room for improvement for the novice. Accordingly, in system 100 in which intelligent agents are modeled to function as clinicians or as mentors for clinicians, the agents are prepared to exploit diagnostic inconsistencies in the same way as experienced people do. This section describes configuring intelligent agents that detect diagnostic inconsistencies. Table 2 shows diagnostic inconsistencies relevant for a clinician.

TABLE 2
Example diagnostic inconsistencies.

| Type | Inconsistency | Opportunity |
|---|---|---|
| 1 | Test results are inconsistent | Do more testing to verify results |
| | with the clinician's | or develop new hypothesis |
| | hypothesis | |
| 2 | Treatment results are | Encourage patient to follow |
| | inconsistent with the clinician's | treatment regimen or change |
| | diagnosis | diagnosis |
| 3 | Information reported by the | Re-evaluate observations or |
| | patient is inconsistent with | improve interaction/dialog |
| | objective observations | with patient or attribute a |
| | | low trustworthiness to patient |

FIG. 13A, FIG. 13B and FIG. 13C are flow charts that illustrate an example method 1300 for executing a reasoning module to determine psychological profile of an patient and clinician and produce simulation output that represents the evaluation of a clinician or patient, according to an embodiment. For purposes of illustration, the independently reasoning agent performing the method 1300 is assumed to be a virtual mentor; but in other embodiments one or more corresponding steps are taken by other independently reasoning agents, such as a virtual patient or virtual clinician. This method includes steps to take advantage of the inconsistencies listed in Table 2.

In step 1301 dialog between a clinician and a patient is monitored to determine confirmation bias, priming bias or framing bias, or some combination. These biases are described above. The results are stored in a model of the physiological profile of the other agents. For example, the results are stored in an instance of a patient chart 670 for the patient kept by the virtual mentor (called a patient psych model hereinafter) and in a different instance of a psychological profile 630 for the clinician kept by the virtual mentor (called a clinician psych model hereinafter).

During step 1301, the clinician, and virtual mentor, develop a hypothesis or diagnosis based on this dialog and other actions, as described in more detail in FIG. 13B. A method 1390 in FIG. 13B is an example embodiment of step 1301. The method 1390 includes steps 1391 through step 1397. In step 1391, the patient statements are processed, e.g., using or receiving output from the deep language processing module 220 of the agent. As a result of this processing the agent determines one or more facts about the patient that are stored in the patient chart. Other information already in the chart is also examined, such as test results and treatment results. In step 1392, it is determined whether sufficient information has been obtained from the dialog and patient chart to form a hypothesis. If not, then in step 1393 the clinician decides to ask the patient for more information and the processing cycle ends until another statement is received from the patient.

If it is determined, in step 1392, that sufficient information has been obtained from the dialog to form a hypothesis, the hypothesis is formed and stored in patient chart and control passes to step 1394. In step 1394, it is determined whether sufficient information has been obtained from the dialog and patient chart to form a diagnosis. If not, then in step 1395 one or more tests are ordered based on the hypothesis to confirm or eliminate the hypothesis. The processing cycle ends until test results are received.

If it is determined, in step 1394, that sufficient information has been obtained from the dialog to form a diagnosis, the diagnosis is formed and stored in the patient chart and control passes to step 1397. In step 1397 one or more treatments are ordered based on the diagnosis of a disease. The processing cycle ends until treatment results are received.

Returning to FIG. 13A, in step 1303 it is determined whether there is no hypothesis or diagnosis despite sufficient grounds. For example, this determination is made if the conditions recorded in the values for sufficient_grounds_to_suspect property 721f of the disease instance are satisfied but the clinician has not shown evidence of working with this hypothesis, e.g., by proposing any of the actions recorded in the values for preferred_action_when_suspected property 721j of the disease instance. Similarly, this determination is made if the conditions recorded in the values for sufficient_grounds_to_diagnose property 721h of the disease instance are satisfied but the clinician has not shown evidence of working with this diagnosis, e.g., by proposing any of the actions recorded in the values for preferred_action_when_diagnosed property 721k of the disease instance. If so, control passes to step 1305 and the need more features bias is added to the clinician psych model. Text is sent to the clinician's evaluation and, in some embodiments, to the user interface 180 to notify a real clinician. Control passes to point A depicted on FIG. 13C to determine psychological profile for patient based on the dialog.

If it is determined in step 1303 that a hypothesis or diagnosis is not avoided, then control passes to step 1307. In step 1307, it is determined whether there is a diagnosis despite insufficient grounds. If so, control passes to step 1309. In step 1309, it is determined whether there are other possible diagnoses based on the same information. For example, the information on the patient chart is compared to concepts for other diseases in the medical knowledge base 150. If any disease is associated with the values from the patient chart, e.g., via values for the sufficient_grounds_to_suspect or sufficient_grounds_to_diagnose properties, then that disease is another possible diagnosis. If such a disease is found, then control passes to step 1311. In step 1311, the jumps to conclusions bias is added to the clinician psych model. Text is sent to the clinician's evaluation and, in some embodiments, to the user interface 180 to notify a real clinician. Control passes to point A. If no such disease is found, then control passes to step 1313.

In step 1313, it is determined whether the diagnosis is supported by the predictive power of the symptoms observed or reported by the patient. For example, this determination is made if the values for predictive_power_of symptoms property 721g of the disease instance are high enough (e.g., 90% predictive) for the combination of symptoms observed or reported. If not, then the clinician might be subject to a false intuition bias, as determined in the next steps. In step 1315, it is determined whether the clinician has sufficient experience to justify forming the conclusion that the combination of symptoms is predictive. For example, it is determined whether the clinician has handled multiple dozens of cases of this particular disease being successfully diagnosed and treated. If so, then, in step 1317, the predictive_power_of_symptoms property 721g for the disease is updated to reflect this clinician's experience. If not, control passes to step 1319. In step 1319, the false intuition bias is added to the clinician psych model. Text is sent to the clinician's evaluation and, in some embodiments, to the user interface 180 to notify a real clinician. Control passes to point A.

Control passes to step 1321 if none of the above biases are detected in the clinician's actions, but other types of false intuition biases are still possible. In step 1321, it is determined whether the clinician is following the protocol for treating one disease despite one or more inconclusive test results. For example, it is determined whether the clinician is treating achalasia based on a basal LES pressure that does not differ from normal by more than the accuracy of the measurement. If treatment is being followed despite an inconclusive test, control passes to step 1323. In step 1323, the illusion of validity bias is added to the clinician psych model. Text is sent to the clinician's evaluation and, in some embodiments, to the user interface 180 to notify a real clinician. Control passes to point A.

If it is determined in step 1321 that the protocol is not based on inconclusive tests, then control passes to step 1325. In step 1325, it is determined whether the clinician is following the protocol for treating one disease despite inconsistency with a simulation or population statistics known to the virtual mentor. In some embodiments, step 1325 includes performing a simulation based on values in the patient's chart 670 augmented by population statistics where values for the patient are unknown. If the protocol is inconsistent with the population statistics or simulation, then control passes to step 1327. In step 1327, the base rate neglect bias is added to the clinician psych model. Text is sent to the clinician's evaluation and, in some embodiments, to the user interface 180 to notify a real clinician. Control passes to point B in FIG. 13C to further refine the bias in this case. If the protocol is not inconsistent with the population statistics or simulation, then control passes to point C in FIG. 13C to define any remaining clinician biases.

Continuing with FIG. 13C, point B passes control to step 1331. In step 1331, it is determined whether the diagnosis that is inconsistent with population statistics comports with repeated personal experience of the clinician. If not, control passes to point C. If so, then in step 1333, the base rate neglect bias is replaced by the small sample bias in the clinician psych model. Text is sent to the clinician's evaluation and, in some embodiments, to the user interface 180 to notify a real clinician. Control passes to point A.

Point C passes control to step 1335. In step 1335, it is determined whether the protocol for treatment of the disease diagnosed is based on the hype level for the treatment, e.g., the amount of attention the treatment receives in the press or in advertisements, or some combination. If not, control passes to point A. If so, then in step 1337, the exposure effect bias is added to the clinician psych model. Text is sent to the clinician's evaluation and, in some embodiments, to the user interface 180 to notify a real clinician. Control passes to point A.

Point A starts steps that address patient biases and passes control to step 1341. In step 1341, it is determined whether a statement by the patient is inconsistent with other objective information, e.g., information in the patient's chart or general medical knowledge. If not, control passes to step 1345. If so, then in step 1343, one or more concepts of the inconsistent statement is noted in the patient chart. In some embodiments, the mentor's detect lying function is activated. If a reported event or state is impossible, then the likelihood of that report being a lie is >99%. For example, an obese patient reports having eaten fewer than 500 calories a day for a month but has not lost any weight is 99% likely to be a lie. If an event is reported to have taken place but its high-probability effects or side effects do not occur, then the likelihood of that report being a lie is a function of: (a) the probability of the given effects or side effects, (b) the difficulty for the patient in performing the event, (c) the embarrassment level for the event or the properties or effects of the event, and (d) the distress level for the event or the properties or effects of the event. The likelihood of the concept being a lie is recorded in the patient chart. For example, dieting is difficult and failing to stick to a diet (a property of a dieting event) can be embarrassing, so if a patient reports adherence to a strict diet but has not lost any weight—i.e., a very high probability effect did not occur—then there is a high probability that the person is lying. Likelihood of a lie is also enhanced when a patient does not a report an event considered unacceptable or frowned upon by the group to which the patient belongs, and yet the event is a typical symptom or property of an event that did happen or is happening. For example, a particularly macho male patient known to have bone cancer might report little or no pain. This is likely to be a lie. Control passes to step 1357 and following, described below, to combine information from several dialog processing cycles.

In step 1345, it is determined whether patient accord for a medical procedure has been reached before sufficient data was provided to warrant the accord. If not, control passes to step 1351. If so, then, in step 1347, a probability for the positive halo bias is added to the patient psych model for the clinician or procedure or both. Control then also passes to step 1357, described below. In step 1351, it is determined whether patient discord for a medical procedure has been reached despite sufficient data having been provided to warrant accord. If not, control passes to step 1355. If so, then, in step 1353, a probability for the negative halo bias is added to the patient psych model for the clinician or procedure or both. Control then also passes to step 1357, described below. In step 1355 a probability for the neutral halo bias is added to the patient psych model for the clinician or procedure or both. Control then also passes to step 1357

In step 1357, the new updates are combined with previous patient psych model updates and the patient chart and population statistics (e.g., a male patient response to procedure with impotence as a side effect) to deduce patient biases and phobias and update the patient chart and psych model. In some embodiments, text is sent to the user interface 180 to notify a real clinician. Control then passes to step 1359.

In step 1359, it is determined whether dialog between patient and clinician has ended. If so the method ends. If not, only the processing cycle ends and control passes back to step 1301 to start a new cycle.

For the virtual mentor to make a successful intervention in advising or tutoring a clinician, during step 1357, the virtual mentor keeps an inventory of goals and their associated plans to make a proper response. On the one hand, the virtual mentor has the “expert” version of the goals and plans that a clinician trainee is attempting to master by using the system 100. Relevant goals include; know patient symptoms (with associated plans that include request-info (i.e., ask a question), conduct physical exam, and detect lying; and (2) collaborate with patient (with associated plans that include show empathy, explain questions, learn patient priorities, biases and other personality traits). On the other hand, the virtual mentor has tutoring goals and that include: avoid omissions by trainee (with associated plans that include warn about omissions); and provide positive feedback to trainee (with associated plans that include reinforce good bedside manner). Returning to method 1300, when the virtual mentor follows the conversation of the clinician and patient, the virtual mentor is playing two roles: the role of expert physician and the role of tutor. As an expert physician, the virtual mentor evaluates every action by the clinician and evaluates if the action correlates with the virtual mentor's own decision of what should be done. If there is an inconsistency between the action of the clinician and the good practices recorded in the virtual mentor's knowledge base, the inconsistency triggers the need for one or more tutoring moves—among them being letting the clinician continue to make the mistake and learn what happens, and alerting the clinician to the mistake.

Using the method 1300, a virtual mentor can point out to a clinician certain things that the clinician might not remember or notice about a particular situation. Such a virtual mentor is particularly useful for clinicians who have less experience overall, who have little experience with a particular constellation of findings, who are under pressures of time and/or fatigue, or who are dealing with difficult non-medical aspects of a case—such as a non-compliant patient.

As exploited in method 1300, in the context of clinical medicine, two types of inconsistency among agents are of particular importance: differences between the factual knowledge bases (ontology and lexicon) of clinicians and patients, and differences in the priorities and preferences of clinicians and patients, as reflected in their decision functions. That is, if a clinician wants to make fast and effective progress with a patient, the clinician should (a) attempt to predict what the patient does and does not know, (b) talk in a language the patient understands, (c) expend effort to make sense of the expectedly non-technical descriptions provided by the patient, and (d) be prepared to teach the patient what the patient needs to know. In addition, if the clinician wants the patient to comply with a treatment protocol, the clinician's goals and plans should collaborate with the patient, taking into consideration the patient's priorities and preferences, even if they do not align with those of the clinician.

It can be seen how the method 1300 deals with and utilizes the inconsistency types listed in Table 2. The type 1 inconsistency involves test results that do not support the clinician's hypothesis about the patient's condition. A common sequence of events in clinical medicine is for a clinician to hypothesize a diagnosis based on a patient interview and then follow up with medical testing. If the testing does not corroborate the hypothesis—thus representing an inconsistency in the clinician's mental model of the patient's condition—this could represent several situations: the hypothesis was wrong; the hypothesis was correct but the condition is not advanced enough to be corroborated by the test; the hypothesis was correct but the test results were flawed. The way the clinician responds to this inconsistency depends upon the interaction of many factors, including at least the severity of the patient's condition (Is “wait and see” an option?), the strength of the hypothesis (Could another hypothesis readily account for the available data?) and the understood reliability of the test (How likely is a testing error?). The opportunities afforded by this type of inconsistency include rethinking the hypothesis and/or verifying the test results, both of which are in service of better management of the patient.

The type 2 inconsistency involves the result of a treatment trial that does not support the clinician's hypothesis about the patient's condition. In clinical medicine, two types of diagnoses can be distinguished: definitive diagnoses are confirmed by medical testing, whereas clinical diagnoses are suggested based on the success of a therapeutic intervention as a diagnostic test. As an example of the latter, if a clinician believes a patient has gastroesophageal reflux disease (GERD) the clinician can prescribe medication to reduce stomach acid; if the medication improves the symptoms, a clinical diagnosis of GERD can be posited. If a diagnostic treatment trial proves ineffective for a patient, this inconsistency could have several explanations: the patient could have shown poor adherence and admitted to it; the patient could have shown poor adherence but hidden it; the hypothesis was correct but the patient was a non-responder; or the hypothesis was incorrect to begin with. The case of admitted lack of adherence is relatively straightforward: barring significant changes in patient health or the patient's evaluation that the patient will again not be able to comply (as might occur if the treatment involves a difficult-to-change lifestyle habit), the treatment protocol is typically repeated. Managing the other three cases, however, involves a decision whose input parameters include, non-exhaustively: an evaluation of the strength of the hypothesis; the availability and likelihood of alternative hypotheses; the efficacy rate of the treatment; and whether or not the patient has a reason to misrepresent his compliance (e.g., a teenage girl afraid of gaining weight might refuse to take a drug with the side effect of weight gain, and might be afraid to admit that to the clinician). The opportunities afforded by this type of inconsistency include the clinician's rethinking of the hypothesis, which might have been incorrect, and the clinician's encouraging the patient to comply with the treatment regime, if the patient ultimately admits to non-compliance. The matter of detecting and managing instances of patients not telling the truth is addressed next.

The type 3 inconsistency involves information reported by the patient that is inconsistent with observations. Intentionally or not, patients do not always tell the truth. Part of the clinician's task is determining whether or not the patient's report is likely to be true and, if not, why. The “why” helps the clinician to remedy the situation in a way that is both compassionate and effective. Consider some of the many reasons why a patient might not tell the truth. The patient fails to understand some information but is embarrassed to admit it. This can be due to many reasons, including insufficient medical literacy, difficulty processing verbal input, or a language barrier. The results include inadvertent misinterpretations of medication dosing, suboptimal post-operative home care, etc.

Another reason for not telling the truth is that the patient fails to understand the importance of something and therefore considers its misrepresentation to be inconsequential. For example, some medications must be taken in a specific temporal relationship to the ingestion of food. If a patient does not understand that the medication loses efficacy if taken otherwise, the patient might report that the medication is taken on schedule even though it is not. In some cases, the patient has beliefs that are valued more highly than telling the whole truth. For example, patients of some socio-cultural background underrepresent their symptoms due the belief that it is not honorable to admit to symptoms. In some cases, the patient has some priority that does not align with the common clinician—patient goal of achieving effective treatment. For example, if a teenage organ-transplant patient is prescribed a high dose of the steroid Prednisone to prevent rejection of the new organ, the patient might balk at the acne it causes as a side effect and decide that clear skin is more important than the potential risks of not taking the medication. Of course, such priorities would be seriously misguided since not taking the medication could lead to loss of the organ and possibly death, which is why the clinician must be on the alert to detect lack of compliance and encourage a subsequent change of behavior.

In some cases, the patient does not want to admit to a lack of willpower, as is necessary for carrying out lifestyle modifications such as weight loss or conquering addiction. In some cases, the patient is embarrassed by a symptom, such as flatulence or loss of sex drive. In some cases, the patient is afraid of legal or other repercussions, as from illicit drug use. The point is that there are a lot of reasons why a patient might not tell the clinician the truth, and the clinician must not only be able to detect such instances but also respond to them in a way that supports the clinician collaboration with the patient. This latter is a cornerstone of patient-centered medicine, which interprets the patient as an active partner in the patient's own health care.

Within the system 100, four core capabilities permit agents to manage inter-agent inconsistencies: the dynamic modeling of the knowledge bases of other agents; the management of linguistic and meta-language paraphrase; the ability to teach and learn new ontological and lexical knowledge; and the ability to collaborate in decision-making. The modeling of these capabilities shows many of the same expectation-oriented characteristics as the modeling of the capabilities that permit agents to exploit the diagnostically useful inconsistencies described above.

### 5. Hardware Overview

FIG. 14 is a block diagram that illustrates a computer system 1400 upon which an embodiment of the invention may be implemented. Computer system 1400 includes a communication mechanism such as a bus 1410 for passing information between other internal and external components of the computer system 1400. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit).). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1400, or a portion thereof, constitutes a means for performing one or more steps of one or more methods described herein.

A sequence of binary digits constitutes digital data that is used to represent a number or code for a character. A bus 1410 includes many parallel conductors of information so that information is transferred quickly among devices coupled to the bus 1410. One or more processors 1402 for processing information are coupled with the bus 1410. A processor 1402 performs a set of operations on information. The set of operations include bringing information in from the bus 1410 and placing information on the bus 1410. The set of operations also typically include comparing two or more units of information, shifting positions of units of information, and combining two or more units of information, such as by addition or multiplication. A sequence of operations to be executed by the processor 1402 constitutes computer instructions.

Computer system 1400 also includes a memory 1404 coupled to bus 1410. The memory 1404, such as a random access memory (RAM) or other dynamic storage device, stores information including computer instructions. Dynamic memory allows information stored therein to be changed by the computer system 1400. RAM allows a unit of information stored at a location called a memory address to be stored and retrieved independently of information at neighboring addresses. The memory 1404 is also used by the processor 1402 to store temporary values during execution of computer instructions. The computer system 1400 also includes a read only memory (ROM) 1406 or other static storage device coupled to the bus 1410 for storing static information, including instructions, that is not changed by the computer system 1400. Also coupled to bus 1410 is a non-volatile (persistent) storage device 1408, such as a magnetic disk or optical disk, for storing information, including instructions, that persists even when the computer system 1400 is turned off or otherwise loses power.

Information, including instructions, is provided to the bus 1410 for use by the processor from an external input device 1412, such as a keyboard containing alphanumeric keys operated by a human user, or a sensor. A sensor detects conditions in its vicinity and transforms those detections into signals compatible with the signals used to represent information in computer system 1400. Other external devices coupled to bus 1410, used primarily for interacting with humans, include a display device 1414, such as a cathode ray tube (CRT) or a liquid crystal display (LCD), for presenting images, and a pointing device 1416, such as a mouse or a trackball or cursor direction keys, for controlling a position of a small cursor image presented on the display 1414 and issuing commands associated with graphical elements presented on the display 1414.

In the illustrated embodiment, special purpose hardware, such as an application specific integrated circuit (IC) 1420, is coupled to bus 1410. The special purpose hardware is configured to perform operations not performed by processor 1402 quickly enough for special purposes. Examples of application specific ICs include graphics accelerator cards for generating images for display 1414, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1400 also includes one or more instances of a communications interface 1470 coupled to bus 1410. Communication interface 1470 provides a two-way communication coupling to a variety of external devices that operate with their own processors, such as printers, scanners and external disks. In general the coupling is with a network link 1478 that is connected to a local network 1480 to which a variety of external devices with their own processors are connected. For example, communication interface 1470 may be a parallel port or a serial port or a universal serial bus (USB) port on a personal computer. In some embodiments, communications interface 1470 is an integrated services digital network (ISDN) card or a digital subscriber line (DSL) card or a telephone modem that provides an information communication connection to a corresponding type of telephone line. In some embodiments, a communication interface 1470 is a cable modem that converts signals on bus 1410 into signals for a communication connection over a coaxial cable or into optical signals for a communication connection over a fiber optic cable. As another example, communications interface 1470 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 1470 sends and receives electrical, acoustic or electromagnetic signals, including infrared and optical signals, that carry information streams, such as digital data.

The term computer-readable medium is used herein to refer to any medium that participates in providing information to processor 1402, including instructions for execution. Such a medium may take many forms, including, but not limited to, non-volatile media, volatile media and transmission media. Non-volatile media include, for example, optical or magnetic disks, such as storage device 1408. Volatile media include, for example, dynamic memory 1404. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 1402, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 1402, except for carrier waves and other signals.

Logic encoded in one or more tangible media includes one or both of processor instructions on a computer-readable storage media and special purpose hardware, such as ASIC 1420.

Network link 1478 typically provides information communication through one or more networks to other devices that use or process the information. For example, network link 1478 may provide a connection through local network 1480 to a host computer 1482 or to equipment 1484 operated by an Internet Service Provider (ISP). ISP equipment 1484 in turn provides data communication services through the public, world-wide packet-switching communication network of networks now commonly referred to as the Internet 1490. A computer called a server 1492 connected to the Internet provides a service in response to information received over the Internet. For example, server 1492 provides information representing video data for presentation at display 1414.

The invention is related to the use of computer system 1400 for implementing the techniques described herein. According to one embodiment of the invention, those techniques are performed by computer system 1400 in response to processor 1402 executing one or more sequences of one or more instructions contained in memory 1404. Such instructions, also called software and program code, may be read into memory 1404 from another computer-readable medium such as storage device 1408. Execution of the sequences of instructions contained in memory 1404 causes processor 1402 to perform the method steps described herein. In alternative embodiments, hardware, such as application specific integrated circuit 1420, may be used in place of or in combination with software to implement the invention. Thus, embodiments of the invention are not limited to any specific combination of hardware and software.

The signals transmitted over network link 1478 and other networks through communications interface 1470, carry information to and from computer system 1400. Computer system 1400 can send and receive information, including program code, through the networks 1480, 1490 among others, through network link 1478 and communications interface 1470. In an example using the Internet 1490, a server 1492 transmits program code for a particular application, requested by a message sent from computer 1400, through Internet 1490, ISP equipment 1484, local network 1480 and communications interface 1470. The received code may be executed by processor 1402 as it is received, or may be stored in storage device 1408 or other non-volatile storage for later execution, or both. In this manner, computer system 1400 may obtain application program code in the form of a signal on a carrier wave.

Various forms of computer readable media may be involved in carrying one or more sequence of instructions or data or both to processor 1402 for execution. For example, instructions and data may initially be carried on a magnetic disk of a remote computer such as host 1482. The remote computer loads the instructions and data into its dynamic memory and sends the instructions and data over a telephone line using a modem. A modem local to the computer system 1400 receives the instructions and data on a telephone line and uses an infra-red transmitter to convert the instructions and data to a signal on an infra-red a carrier wave serving as the network link 1478. An infrared detector serving as communications interface 1470 receives the instructions and data carried in the infrared signal and places information representing the instructions and data onto bus 1410. Bus 1410 carries the information to memory 1404 from which processor 1402 retrieves and executes the instructions using some of the data sent with the instructions. The instructions and data received in memory 1404 may optionally be stored on storage device 1408, either before or after execution by the processor 1402.

FIG. 15 illustrates a chip set 1500 upon which an embodiment of the invention may be implemented. Chip set 1500 is programmed to perform one or more steps of a method described herein and includes, for instance, the processor and memory components described with respect to FIG. 14 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1500, or a portion thereof, constitutes a means for performing one or more steps of a method described herein.

In one embodiment, the chip set 1500 includes a communication mechanism such as a bus 1501 for passing information among the components of the chip set 1500. A processor 1503 has connectivity to the bus 1501 to execute instructions and process information stored in, for example, a memory 1505. The processor 1503 may include one or more processing cores with each core configured to perform independently. A multi-core processor enables multiprocessing within a single physical package. Examples of a multi-core processor include two, four, eight, or greater numbers of processing cores. Alternatively or in addition, the processor 1503 may include one or more microprocessors configured in tandem via the bus 1501 to enable independent execution of instructions, pipelining, and multithreading. The processor 1503 may also be accompanied with one or more specialized components to perform certain processing functions and tasks such as one or more digital signal processors (DSP) 1507, or one or more application-specific integrated circuits (ASIC) 1509. A DSP 1507 typically is configured to process real-world signals (e.g., sound) in real time independently of the processor 1503. Similarly, an ASIC 1509 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1503 and accompanying components have connectivity to the memory 1505 via the bus 1501. The memory 1505 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 1505 also stores the data associated with or generated by the execution of one or more steps of the methods described herein.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article.

What is claimed is:

1. A method comprising:
identifying an independently reasoning agent in a medical clinical information processing system configured to simulate interactions between a clinician and a patient;
determining, on the system, psychological profile data that indicates one or more personality traits for the agent;
storing psychological profile data on the system in a hierarchical data structure for a natural language processing system; and
determining simulation output from the system based at least in part on the psychological profile data.

2. A method as recited in claim 1 wherein:
the agent represents a virtual patient;
the system receives input from a clinician trainee; and
the simulation output indicates a response of the virtual patient to the input by the trainee.

3. A method as recited in claim 1 wherein:
the agent represents a clinician;
the system receives input from the clinician; and
the simulation output indicates a performance or personality evaluation of the clinician.

4. A method as recited in claim 1 wherein:
the agent represents an actual patient;
a different agent represents a virtual mentor;
the system receives input from a clinician; and
the simulation output indicates a recommended diagnosis for the actual patient.

5. A method as recited in claim 1 wherein:
the agent represents an actual patient;
a different agent represents a virtual mentor;
the system receives input from a clinician; and
the simulation output indicates a recommended action or procedure for the actual patient.

6. A method as recited in claim 1 wherein:
the agent represents an actual patient;
the system receives input from a clinician; and
the simulation output indicates an personality evaluation of the actual patient.

7. A method as recited in claim 1, wherein the personality traits of the agent comprise:
one or more values for one or more corresponding first parameters selected from a group comprising trustfulness, lifestyle type, tolerance to risk, tolerance to pain, tolerance to disability and suggestibility; and
one or more values for one or more corresponding second parameters selected from a group comprising intellect, interest in learning, compassion, perception, trustworthiness, self image, affability, temper, education level, areas of expertise, beliefs, biases and phobias.

8. A method as recited in claim 1, wherein determining psychological profile data further comprises:
determining an initial value for one or more parameters of the personality traits for the agent based on statistics of a population to which the agent belongs; and
substituting a subsequent value for one or more parameters of the personality traits based on data provided by the agent.

9. A method as recited in claim 1, wherein determining psychological profile data further comprises determining a value for one or more parameters of the personality traits based on natural language processing of text generated by the agent.

10. A method as recited in claim 1, further comprising simulating, on the system, a physiological state of the agent.

11. A method as recited in claim 4, wherein the recommended diagnosis is based at least in part on a measure of predictive power of symptoms for a disease.

12. A method as recited in claim 4, wherein the recommended diagnosis is based at least in part on a probability of a disease in a population cluster to which the agent belongs.

13. A method as recited in claim 4, wherein the recommended diagnosis is that the patient suffers from achalasia.

14. A method as recited in claim 12, wherein the recommended diagnosis is that the patient suffers from achalasia based at least in part on a ratio of a number of contracting neurons to a number of relaxing neurons.

15. A method as recited in claim 1, wherein determining simulation output further comprising performing processing of text from a different independently reasoning agent in the medical clinical information processing system based at least in part on the psychological profile data.

16. A method as recited in claim 1, wherein:
the method further comprises performing natural language processing to generate and interpret text exchanged between a plurality of independently reasoning agents in the system; and
the simulation output is further based, at least in part, on the natural language processing of text exchanged between the plurality of agents.

17. A method as recited in claim 16, wherein performing natural language processing further comprises storing concepts of the natural language processor in the same hierarchical data structure as the psychological profile data.

18. A method as recited in claim 16, wherein the psychological profile data is based on the concepts of the natural language processor.

19. A method as recited in claim 16, wherein performing natural language processing and determining simulation output further comprise executing one or more instances of a single natural language processing engine.

20. A non-transient computer-readable medium carrying one or more sequences of instructions, wherein execution of the one or more sequences of instructions by one or more processors causes the one or more processors to perform the steps of:
identifying an independently reasoning agent in a medical clinical information processing system configured to simulate interactions between a clinician and a patient;
determining psychological profile data that indicates one or more personality traits for the agent;
storing psychological profile data in a hierarchical data structure for a natural language processing system; and
determining simulation output based at least in part on the psychological profile data.

21. An apparatus comprising:
at least one processor; and
at least one memory including one or more sequences of instructions,
the at least one memory and the one or more sequences of instructions configured to, with the at least one processor, cause the apparatus to perform at least the following,
identifying an independently reasoning agent in a medical clinical information processing system configured to simulate interactions between a clinician and a patient;
determining psychological profile data that indicates one or more personality traits for the agent;
storing psychological profile data in a hierarchical data structure for a natural language processing system; and
determining simulation output based at least in part on the psychological profile data.
